(19) United States
(12) Patent Application Publication
(10) Pub. No.: US 2025/0162167 A1
(43) Pub. Date: May 22, 2025

(54) MULTI-STORE MESH NETWORK OF BEVERAGE ROBOTS AND ASSOCIATED SYSTEMS AND METHODS

(71) Applicant: BOTRISTA, INC., San Francisco, CA (US)

(72) Inventors: Wu-Chou KUO, San Francisco, CA (US); Yu-Wei CHEN, New Taipei City (TW); Alexander Milton FRIEDMAN, San Francisco, CA (US)

(21) Appl. No.: 18/821,159

(22) Filed: Aug. 30, 2024

Related U.S. Application Data
(60) Provisional application No. 63/600,955, filed on Nov. 20, 2023.

(51) Int. Cl. B25J 11/00; B25J 9/16

(52) U.S. Cl. CPC B25J 11/0045; B25J 9/1653; B25J 9/1661; B25J 9/1679

(57) ABSTRACT

A mesh network of food and/or beverage robots across multiple store locations, and associated systems and methods, are disclosed herein. For example, a method of operating the mesh network can include receiving an order for a beverage from a first beverage robot in a first store location and identifying one or more beverage robots that are available to prepare the beverage. The second robots can be identified as available based on one or more ingredients required by a recipe for the beverage. The method can also include, for each individual beverage robot identified, determining an estimated reception time at the individual beverage robot based on when a user would receive the order from the individual beverage robot. The method can then include presenting estimated reception times to the user, receiving selection of a beverage robot, and sending the order to the selected beverage robot.

### CROSS-REFERENCE TO RELATED APPLICATIONS

The present application claims priority to U.S. Provisional Patent Application No. 63/600,955, titled “FOOD STERILIZATION SYSTEM, INGREDIENT MIXING SYSTEM, MULTIPURPOSE BLENDING SYSTEM, BEVERAGE MENU GENERATOR, CONTAINER SQUEEZING DEVICES, FRYER APPARATUS, COFFEE PREPARATION APPARATUS, FLUID DISPENSING SYSTEM, AND RELATED CLOUD SYSTEM,” filed Nov. 20, 2023, the entirety of which is incorporated herein by reference.

### TECHNICAL FIELD

The present technology is generally directed to a mesh network of robots and more specifically to systems and methods for operating a mesh network of beverage and/or food robots in varying geographic locations.

### BACKGROUND

Freshly made beverages are typically more desirable to consumers than factory-produced, canned or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. The fresh preparation, however, typically requires the time and attention of vendor personnel, which can slow down order production, causing customer dissatisfaction, reducing the volume of orders vendors can produce, and/or increasing the costs per order. To meet these challenges, vendors have increasingly automated portions, or all, of the production of beverages.

Automation brings about another set of challenges. For example, automating beverage productions requires that vendors be able to maintain, diagnose, and fix the automation systems. Additionally, vendors must be able to track and monitor ingredients and ingredient inventory for the automated systems to avoid preparing contaminated drinks. Still further, vendors must be able to track orders through the automated system to ensure customer satisfaction with the timing, resulting orders, and overall experience.

### BRIEF DESCRIPTION OF THE DRAWINGS

FIG. 1 is a schematic diagram of a system for operating food and/or beverage robots in accordance with some embodiments of the present technology.

FIG. 2 is a schematic network diagram of a system for operating a network of food and/or beverage robots in accordance with some embodiments of the present technology.

FIG. 3 is a block diagram of a platform for operating a network of beverage robots in accordance with some embodiments of the present technology.

FIG. 4 is a block diagram of a subsystem for a beverage robot in accordance with some embodiments of the present technology.

FIG. 5 is a schematic front view of a beverage robot configured in accordance with some embodiments of the present technology.

FIG. 6 is a schematic diagram of a mesh network with a plurality of beverage robots in different geographic locations configured in accordance with some embodiments of the present technology.

FIG. 7 is a flow diagram of a process for operating a mesh network with a plurality of beverage robots in accordance with some embodiments of the present technology.

FIGS. 8A-8E are wireframe diagrams illustrating various user interfaces for interacting with the mesh network in accordance with some embodiments of the present technology.

FIG. 9 is a flow diagram of a process for operating a mesh network with a plurality of beverage robots in accordance with some embodiments of the present technology.

FIG. 10 is a wireframe diagram illustrating another user interface for interacting with the mesh network in accordance with some embodiments of the present technology.

FIG. 11 is a flow diagram of a process for improving consistency in the beverages produced by a mesh network of beverage robots in accordance with some embodiments of the present technology.

FIG. 12 is a flow diagram of a process for timing orders in production at a plurality of beverage robots in accordance with some embodiments of the present technology.

FIG. 13 is a flow diagram of a process for managing a network having a plurality of beverage robots in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

A mesh network of food and/or beverage robots across multiple store locations, and associated systems and methods, are disclosed herein. As discussed in more detail below, for example, embodiments of the present technology include processes related to receiving an order for a beverage from a first store (e.g., café, restaurant, coffee shop, tea shop, and/or any other suitable vending location), identifying one or more second stores available to produce the beverage, and presenting each of the options to a user associated with the order. The user can then choose and/or select from the options based on where they can receive the beverage fastest, which locations are otherwise convenient (e.g., along a commuting route), and/or which locations they prefer. The processes can then include sharing information about a recipe for the beverage between store locations to ensure that the beverage is prepared according to a customized/tailored recipe that is specific to the first store. As a result, for example, the user can receive a beverage with the same (or similar) flavor profile from a wider variety of locations to increase the speed and/or convenience associated with ordering their preferred beverages.

For ease of reference, the food/beverage robots, and components thereof, are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that the food/beverage robots, and components thereof, can be moved to, and used in, different spatial orientations without changing the structure and/or function of the disclosed embodiments of the present technology.

Further, it will be understood that when a component is referred to as being “positioned on,” “positioned above,” “connected to,” “engaged with,” or “coupled with” another component, it can be directly on, directly connected to, or directly engaged with the other component, or intervening component may be present. In contrast, when a component is referred to as being “directly on,” “directly connected to,” or “directly engaged with” another component, there are no intervening components present.

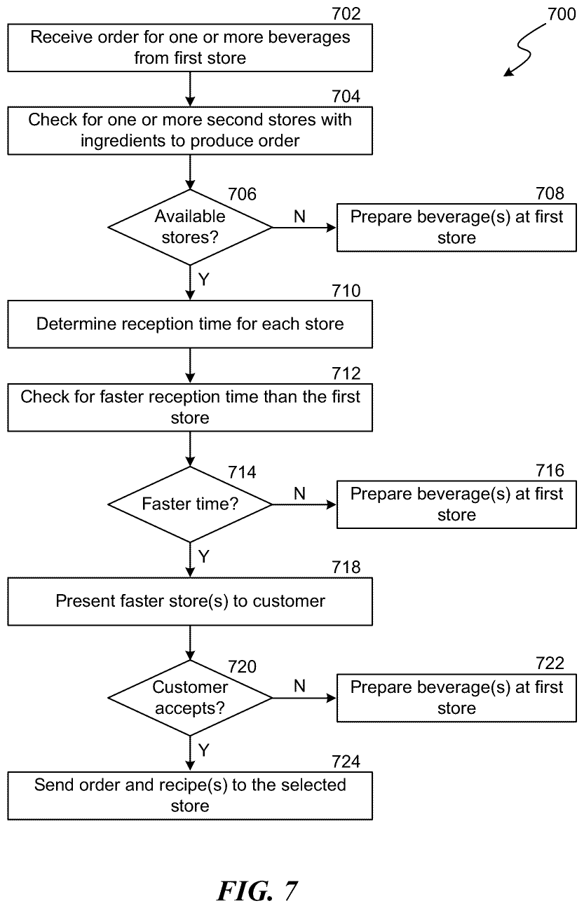

Still further, although primarily discussed herein in the context of managing a mesh network of beverage robots, one of skill in the art will understand that the scope of the invention is not so limited. Purely by way of example, the methods disclosed with respect to FIGS. 7-12 can also be used to receive, assign, and manage orders from one or more food robots in addition to (or instead of) one or more beverage robots.

Conventional restaurants, cafés, coffee shops, tea shops, and/or the like prepare beverages in an order by hand. The manual preparation can be time-consuming, however, which can create a limit on the maximum volume of drinks that a store can prepare in a given window. Further, stores (sometimes also referred to herein as “vending locations”) are typically forced to limit the range of beverage options to help streamline and/or simplify the manual preparation involved in creating the beverages. Still further, manual preparation can lead to inconsistencies between beverages due to human error, differences in staff, and/or the like. Additionally, conventional stores are limited to sales via their physical locations, which can be inconvenient and/or time-consuming for customers to travel to, particularly during periods of peak demand. This problem is exacerbated by the inconsistencies with manual preparation that may cause their order to be not ready when they arrive, stale (e.g., cooled, melted ice, and/or otherwise not fresh) when they arrive, and/or different from their expectations.

To help address these issues, the systems and methods disclosed herein provide one or more beverage robots to the stores. Each of the beverage robots can store a variety of ingredients required to prepare a variety of beverages offered at the store. When the store receives an order, the beverage robots can prepare the beverages to produce the order based on recipes for each of the beverages. The automatic preparation in the beverage robots can help increase throughput at the store, allowing the store to serve more beverages during periods of increased demand (e.g., a lunch rush) than stores with only manual preparation. Further, the beverage robots can more precisely follow the recipes for each of the beverages without requiring any training for store personnel (e.g., baristas, chefs, cooks, bartenders, and/or the like).

Still further, the systems and methods disclosed herein can utilize the beverage robots to combine multiple store locations (e.g., multiple locations for a chain, multiple different stores, stores of different types, and/or the like) in a mesh network. For example, because the beverage robot(s) in a second store do not need to be trained, the beverage robot(s) are capable of preparing the beverage orders at a first store as long as the beverage robot(s) have the necessary ingredients. Accordingly, as discussed in more detail below, the systems and methods disclosed herein can link multiple stores together to allow users to order beverages from a first restaurant and receive the beverages from various other stores that are closer to the user, more convenient to the user, and/or have a shorter in-store wait time.

The implementation of the mesh network across multiple stores, however, creates numerous technical challenges. For example, the beverages from the first store can be specific to the first store (e.g., associated with a customized and/or tailored recipe) that is not known and/or not available to the other stores. As a result, while the other stores have the ingredients necessary to prepare the beverages, the beverage robots will not have the relevant recipes to follow. In another example, while various stores may have generally similar ingredients (e.g., juice concentrates of the same type, simple syrups, and/or the like), there can be variations in the specifics of those ingredients. Purely by way of example, juice concentrates from different batches and/or different suppliers can have different flavor profiles that affect the resulting taste of beverages prepared according to the same recipe. As a result, even when the other stores have the recipes associated with beverages from the first store, it can be difficult to prepare beverages with consistent flavor profiles.

To overcome these technical deficiencies, the systems and methods disclosed herein include various systems and processes for sharing recipe information and/or adjusting recipes based on ingredients available at different stores. For example, the systems and methods disclosed herein can share customized recipes with the beverage robot(s) in different stores in response to a user's selection of a store to receive their order from. As a result, the first store can maintain some secrecy in their recipes while the second store is able to prepare the beverages in each order. In another example, the systems and methods disclosed herein can adjust recipes based on ingredient information and/or requested modifications before sharing the recipes with the different stores. As a result, the recipe information provided to the beverage robots in a second store can cause the beverage robots to produce beverages with similar (or identical) flavor profiles as if prepared by the first store.

### Examples of Suitable Systems for Operating Food and/or Beverage Robots in Accordance With Embodiments of the Present Technology

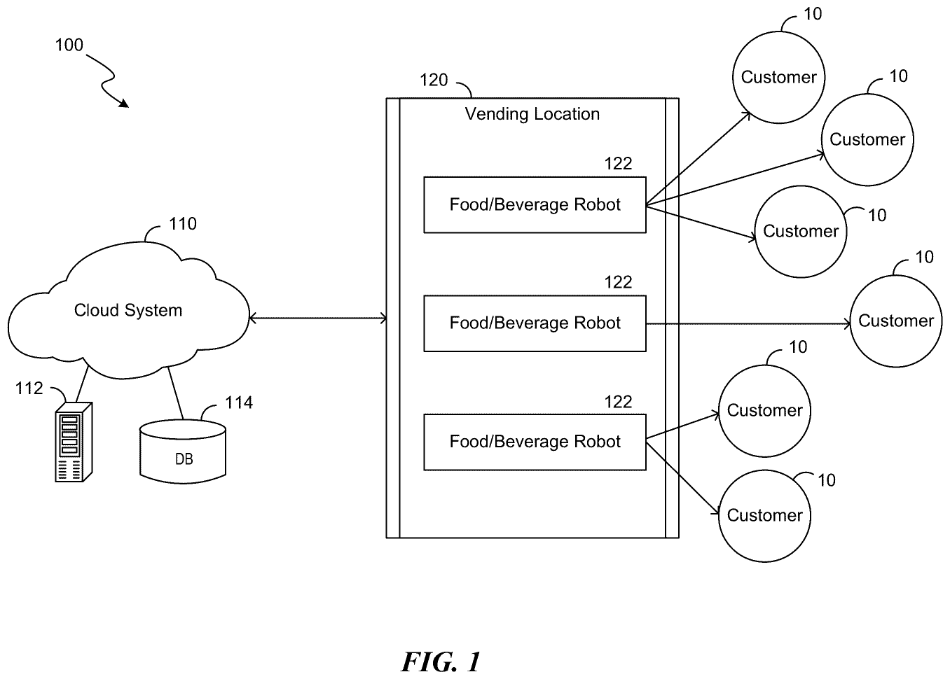

FIG. 1 is a schematic diagram of a system 100 for operating food and/or beverage robots in accordance with some embodiments of the present technology. The system 100 can interconnect a remote system 110 with one or more vending locations 120 (one illustrated in FIG. 1) to operate one or more food/beverage robots 122 (three illustrated in FIG. 1) at each of the vending location(s) 120. As discussed in more detail below, the food/beverage robots 122 can automate the preparation of various food items and/or beverages for customers 10 at the vending location(s) 120. The automation, in turn, can allow the vending location(s) 120 to provide a wider variety of food items and/or beverages, increase the number of the customers 10 the vending location(s) 120 can serve, improve consistency in the taste of the food items and/or beverages, and/or increase transparency into a status of an order and/or an estimated completion time for the order.

As illustrated in FIG. 1, the remote system 110 can include one or more servers 112 (one illustrated in FIG. 1) as well as one or more databases 114 (one illustrated in FIG. 1). The server(s) 112 can be an edge server and/or a cloud-based server with one or more server computing devices configured to perform various operations in support of the food/beverage robots 122. Purely by way of example, as discussed in more detail below, the server(s) 112 can manage orders for food/beverages, queue orders between different sets of the food/beverage robots 122 and/or between different vending location(s) 120, manage and/or monitor food/beverage ingredients, monitor the operation of the food/beverage robots 122 (e.g., check cleaning status, monitor for part malfunctions, predict and/or schedule maintenance, and/or the like), maintain and/or share food/beverage recipes, modify recipes to account for variances in ingredients, and/or the like. The server(s) 112 can include various hardware, such as processing units (e.g., GPUs, CPUs, APUs, and/or the like), working memory, storage memory, input/output devices, displays (e.g., LCD display screens, LED display screens, OLED display screens, and/or the like), a network card, video card, audio card, USB ports, and/or the like. Further, the server(s) 112 are illustrated as a single server, the server(s) 112 can each be a distributed computing environment encompassing multiple computing devices located at the same or at geographically disparate physical locations. Further, the server(s) 112 can correspond to a group of servers supporting the food/beverage robots 122.

The database(s) 114 can warehouse (e.g., store) information, such as drink recipes, lot information or ingredients, stocking keeping units (SKU) information, part information, and/or the like. Though database(s) 114 is illustrated as a single unit, the database(s) 114 can each be a distributed computing environment encompassing multiple computing devices, can be located within one of the server(s) 112 (and/or within a computing device of the server(s) 112), or can be located at the same or at geographically disparate physical locations. The database(s) 114 can include one or more memories, each of which can include various hardware devices for volatile and non-volatile storage. For example, the memory can comprise random access memory (RAM), various caches, CPU registers, read-only memory (ROM), and writable non-volatile memory, such as flash memory, hard drives, CDs, flash drives, magnetic storage devices, and/or the like. The memory is not a propagating signal divorced from underlying hardware; the memory is thus non-transitory. Further, the memory can include sections, such as a program memory section that stores programs and software related to the operation of the food/beverage robots 122 and/or a data memory section that stores data related to the operation of the food/beverage robots 122.

The remote system 110 can be communicatively coupled to various computing devices at the vending location(s) 120 through a network connection (e.g., an internet connection, cellular network, and/or the like). For example, the communication can be implemented through the network using TCP/IP protocols, a Q-LAN protocol, or others. In a specific, non-limiting example, each of the food/beverage robots 122 can include computing components that allow the food/beverage robots 122 to communicate individually (or collectively) with the remote system 110 and/or various other computing devices at the vending location(s) 120 (e.g., point-of-sale systems, on-site servers, and/or the like).

As discussed in more detail below, the communication can allow the remote system 110 to support and/or control (partially or fully) various operations of the food/beverage robots 122 and/or various related operations. For example, the vending location(s) 120 can be any location that serves food items and/or beverages (e.g., a store, café, coffee shop, tea shop, restaurant, food truck, brewery, bar, hotel, resort, conference center, stadium, entertainment center (e.g., a theater, music venue, arcade, bowling center, pool hall, theme park, and/or the like), and/or any other suitable location, sometimes also referred to collectively herein as a “store”). The remote system 110 can communicate with the food/beverage robots 122 in the vending location(s) 120 to store and/or communicate recipes for orders; monitor ingredients available at the food/beverage robots 122; assign orders (or portions thereof) to the food/beverage robots 122; time the completion of orders based on other aspects of the order, a location of the customers 10, a location of a delivery person, and/or the like; monitor a cleaning and/or health status of the food/beverage robots 122; and/or any other suitable operation.

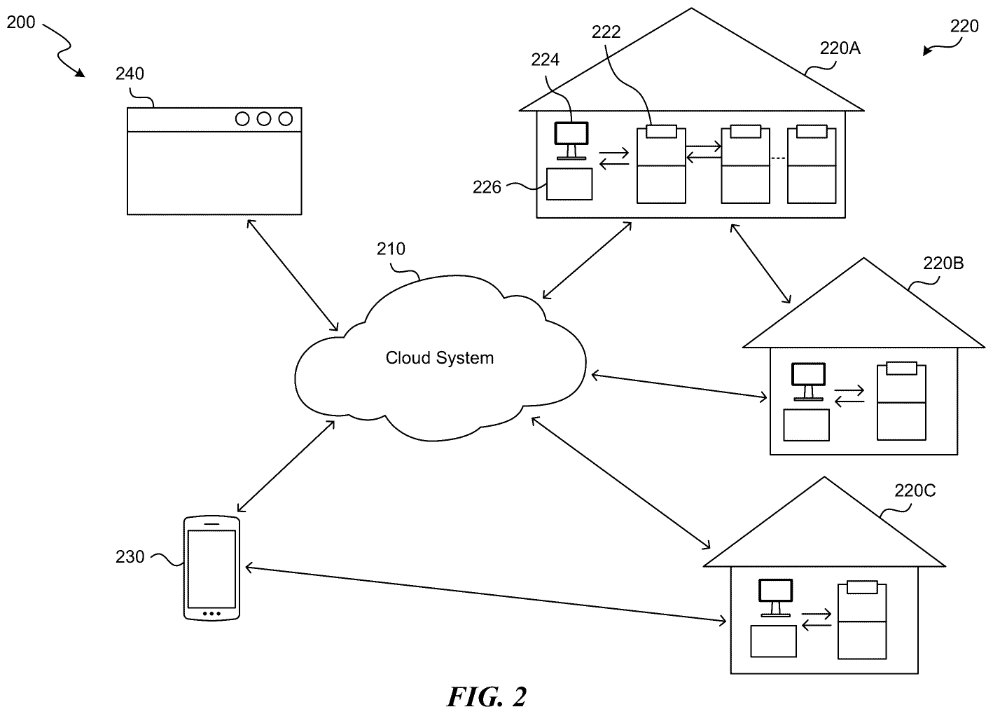

FIG. 2 is a schematic network diagram of an environment in which embodiments of the present technology can operate. The environment can include a remote system 210 (e.g., a cloud computing system) generally similar (or identical) to the remote system 110 discussed above with respect to FIG. 1. For example, the remote system 210 can include one or more servers (e.g., the servers of FIG. 1) as well as one or more databases (e.g., the databases 114 of FIG. 1) that allow the remote system 210 to support and/or facilitate various operations in the environment 200. As further illustrated in FIG. 2, the environment 200 can also include one or more vending locations 220 (three illustrated in FIG. 2, referred to individually as first-third vending locations 220A-220C), one or more client computing devices 230 (one illustrated in FIG. 2), and one or more third-party platforms 240 (one illustrated in FIG. 2). As further illustrated in FIG. 2, the vending locations 220, client computing devices 230, and third-party platforms 240 are each communicatively coupled to the remote system 210 (e.g., via a network connection). As a result, as discussed in more detail below, the remote system 210 can help support, facilitate, and/or control operations at each of the vending locations 220, the client computing devices 230, and/or the third-party platforms 240. Additionally, or alternatively, the remote system 210 can provide a connection and/or facilitate communications between the vending locations 220, the client computing devices 230, and/or the third-party platforms 240.

Similar to the discussion above, the vending locations 220 (sometimes also referred to herein as “stores”) can include any location providing food and/or beverage sales to customers. In a non-limiting example, the first vending location 220A can be a restaurant, the second vending location 220B can be a food truck, and the third vending location 220C can be a coffee shop. Further, each of the vending locations 220 can include one or more food/beverage robots 222, a point-of-sale (POS) system 224, and/or an onsite computing system 226. The food/beverage robots 222, the POS system 224, and the onsite computing system 226 can be communicably coupled by a network (e.g., the internet, a local area network (LAN), a wide area network (WAN), and/or the like), one or more wired connections, and/or various shortrange wireless communication components (e.g., Bluetooth®, Zigbee®, Z-Wave®, HaLow®, Wi-Fi, NearLink, near-field communication (NFC), low-power WAN, ultra-wideband (UWB), and/or the like). As a result, the food/beverage robots 222, the POS system 224, and the onsite computing system 226 can help partially (or fully) automate transactions and the production of orders received at each of the vending locations 220.

For example, as discussed in more detail below, the food/beverage robots 222 can store and/or have access to any suitable number of ingredients and automate the preparation of various food items and/or beverages. Purely by way of example, the food/beverage robots 222 can store a plurality of bag-in-boxes (BIBs) that each has concentrated ingredients for various different beverages (e.g., juice blends, sodas, teas, boba drinks, coffee drinks, energy drinks, matés, milk drinks, milkshakes, lemonades, flavored water, flavored sparkling water, mocktails, probiotic drinks, and/or the like). The food/beverage robots 222 can access one or more of the BIBs in response to an order and automatically mix the ingredients to prepare one or more beverages in the order. The POS system 224 can include various devices to receive and process transactions and generate orders for the food/beverage robots 222. For example, the POS system 224 can include cash registers, electronic terminals (e.g., touchscreen terminals), virtual terminals (e.g., accessible through an app on a customer's phone, a web browser, and/or the like), credit card readers, chip readers, and/or the like. Once a transaction is processed, for example, the POS system 224 can send the order(s) associated with the transaction to the food/beverage robots 222 to be prepared. The onsite computing system 226 can include desktop computers, laptops, server computing devices, databases and other storage devices, and/or the like to provide computational services (e.g., order processing, order distribution, order management, order change requests, recipe management, ingredient management, maintenance scheduling, cleaning scheduling, quality control, and/or the like) for the POS system 224 and/or the food/beverage robots 222. Said another way, the onsite computing system 226 can provide local services that support the operations discussed herein as additional, or peripheral, computing devices to the remote system 210.

The client computing devices 230 can include wireless smartphones, wireless tablets, desktop computers and other computer systems (e.g., server computers), wireless laptops, digital assistants, virtual assistants, other smart devices (e.g., smart watches, smart glasses, and/or the like), internet-of-things (IoT) devices, and/or the like. The client computing devices 230 allow users (e.g., customers, vending location staff and/or personnel, maintenance personnel, brand personnel, and/or the like) to access different components of the environment 200. For example, a customer can access the remote system 210 and/or the POS system 224 in any of the vending locations 220 through their smartphone to place an order. In another example, a manager at one of the vending locations 220 can access the remote system 210 and/or the food/beverage robots 222, the POS system 224, and/or the onsite computing system 226 through a laptop computer to monitor information on the vending locations 220 (e.g., stock levels for the ingredients, maintenance warnings/schedules, cleaning schedules, order history, order trends, and/or the like).

The third-party platforms 240 can be implemented on various suitable computing devices and/or systems (e.g., server computing systems, laptop computers, desktop computers, smart devices, and/or the like). The third-party platforms 240 can provide peripheral services to the remote system 210 and/or any of the other components in the environment 200. Purely by way of example, the third-party systems can include a sales, marketing, and deployment tracking platform (e.g., ClickUp and/or the like) that helps the remote system 210 monitor the deployment of the food/beverage robots 222, sales across the environment 200, and/or the like. Additionally, or alternatively, the sales, marketing, and deployment tracking platform can help any of the vending locations 220 monitor the deployment of the food/beverage robots 222, track their sales, market their food/beverage options, and/or the like.

In another example, the third-party platforms 240 can include a data visualization and analytics platform (e.g., Tableau, Looker, and/or the like). The data visualization and analytics platform can work with raw data from the remote system 210 and/or any of the vending locations 220 (or any specific components therein) to summarize and/or analyze the data. In a specific, non-limiting example, the data visualization and analytics platform can identify sales trends in the data for the remote system 210, allowing the remote system 210 to make recommendations to the vending locations 220 on what ingredients to stock, popular recipe trends, recipes trends specific to the vending location area and/or type, and/or the like. Additionally, or alternatively, the data visualization and analytics platform can record data on needed maintenance, maintenance schedules, cleaning schedules, and/or the like to help the remote system 210 and/or the vending locations 220 track the status of the food/beverage robots 222.

In yet another example, the third-party platforms 240 can include a customer support platform (e.g., Freshdesk and/or the like). The customer support platform can supplement (or provide) a service dashboard in the remote system 210 to help the remote system 210 provide services to the vending locations 220. In a specific, non-limiting example, the customer support platform can use the raw data (and/or analyses from the data visualization and analytics platform) to respond to calls from the vending locations 220 regarding the status of the food/beverage robots 222. Further, the customer support platform can help proactively monitor and manage the health of the food/beverage robots 222 (e.g., using data from the data visualization and analytics platform to schedule maintenance ahead of a breakdown). Additionally, or alternatively, the vending locations 220 can be connected to the customer support platform through the remote system 210 to provide customer support at the vending locations (e.g., answer questions about transactions, complaints about orders, suggestions for the vending locations 220, issue refunds, and/or the like).

In yet another example, the third-party platforms 240 can include an enterprise resource planning (ERP) platform. The ERP platform can help the remote system 210 and/or the vending locations 220 manage invoices, orders, inventory, and/or the like. In a specific, non-limiting example, the remote system 210 can be integrated with the ERP platform to track SKU information on the ingredients used in each of the food/beverage robots 222 to alert the vending locations 220 and/or automatically order additional inventory when the ingredients are low. Additionally, or alternatively, the vending locations 220 can access the ERP platform to help track the invoices associated with ingredients they order, and/or the like.

In yet another example, the third-party platforms 240 can include a third-party logistics (3PL) platform (e.g., Logiwa). The 3PL platform can help the remote system 210 manage warehouse and shipping logistics to provide and/or install the food/beverage robots 222 in the vending locations 220, provide and/or install parts for the food/beverage robots 222, provide ingredients for the vending locations 220, and/or the like. Additionally, or alternatively, the 3PL platform can help the remote system 210 manage various special orders (e.g., modifications to customize the food/beverage robots 222 to any of the vending locations 220, customized ingredient orders, and/or the like) from the vending locations 220.

Although discussed above as being connected through the remote system 210, the vending locations 220, the client computing devices 230, and/or the third-party platforms 240 can communicate directly. For example, as illustrated in FIG. 2, the first vending location 220A can directly communicate with the second vending location 220B. The direct communication can allow, for example, the first and second vending locations 220A, 220B to share orders (or portions thereof) independent from control and/or supervision from the remote system 210. The direct communication and independent control, in turn, can reduce the resources required in the remote system 210 to support the operation of the first and second vending locations 220A, 220B. In another example, the client computing device 230 can communicate directly with the third vending location 220C. The direct communication can allow, for example, the third vending location 220C to receive order(s) directly from the client computing device 230, without any delays relaying the order through the remote system 210.

Further, although the vending locations 220 are illustrated in FIG. 2 as each having at least one of the food/beverage robots 222, the POS system 224, and the onsite computing system 226, it will be understood that the systems and methods disclosed herein are not so limited. For example, any of the vending locations 220 can omit the food/beverage robots 222 and instead communicate with another of the vending locations 220 (directly or through the remote server) to produce orders. In another example, any of the vending locations 220 can omit the POS system 224 and/or the onsite computing system 226. Instead, the remote system 210 can receive, distribute, manage, and/or track orders on behalf of the vending locations 220 and/or provide any necessary computational services.

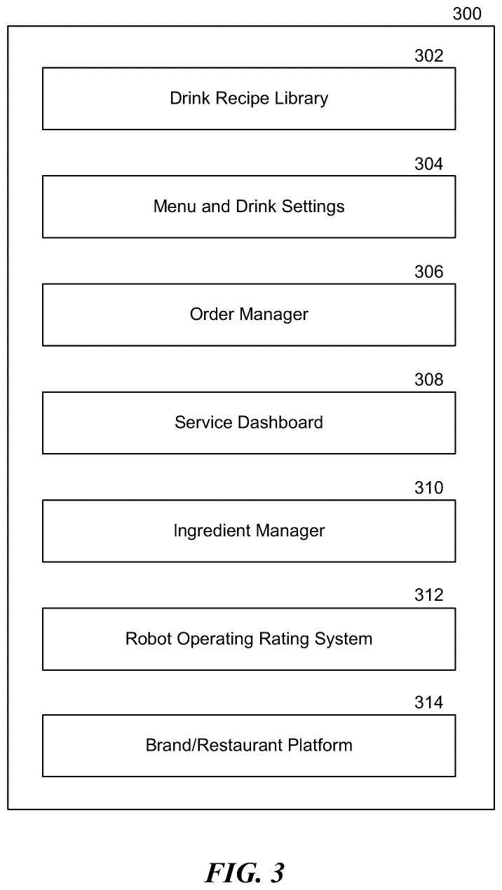

FIG. 3 is a block diagram of a platform 300 for operating a network of beverage robots in accordance with some embodiments of the present technology. The platform 300 can be implemented in one or more computing devices, such as the remote system 210 discussed above with reference to FIG. 2, to help support, manage, and/or control operations in a variety of vending locations. For example, the platform 300 can be implemented on one or more processors of a computing system with access to any suitable number of storage components to facilitate the operations of the platform 300 as described herein. Further, as illustrated in FIG. 3, the platform 300 can include one or more modules (seven illustrated in FIG. 3, referred to individually as first-seventh modules 302-314), various examples of which are discussed in more detail below.

The first module 302 can include a drink recipe library. The drink recipe library can include information on the proportions of ingredients for a variety of beverages, such as juice blends, sodas, teas, boba drinks, coffee drinks, energy drinks, matés, milk drinks, milkshakes, lemonades, flavored water, flavored sparkling water, mocktails, probiotic drinks, and/or the like. In some embodiments, the recipes include specific ratios (e.g., percentages of different ingredients such as 5% a first juice, 5% a second juice, 1% simple syrup, 40% ice, and 39% water; ratios of ingredients such as 1 part tea concentrate, 0.5 parts ice, 1 part water; and/or the like). Additionally, or alternatively, the recipes can include various nutrient tables, acidity information, sweetness information, concentration information, and/or the like related to how a beverage should taste. In such embodiments, the drink recipe library can allow beverage robots to vary the exact ratios of ingredients to account for variations in the ingredients (e.g., using more or less of a juice concentrate based on variations in different batches, using more or less simple syrup to compensate for variations in the acidity of batches of coffee concentrate, and/or the like). Further, the drink recipe library can have recipes that allow beverage robots to produce beverages of any size, beverages in a range of sizes (e.g., common sizes such as 16 ounces (oz), 20 oz, 24 oz, and/or the like), and/or only beverages of a specified size (e.g., 16 oz of an energy drink to limit the caffeine provided in a single beverage).

Still further, the drink recipe library in the first module 302 can include a variety of generic recipes, a list of previously customized recipes, branded recipes, and/or the like. The generic recipes can be baseline recipe suggestions for a variety of drinks that a vending location can customize based on taste preferences and/or customer feedback. Any customized recipe can then be stored to be accessed, used, and/or customized by other vending locations. The branded recipes can be specific to drink and/or beverage brands (e.g., juice brands, sports drink brands, coffee brands, tea brands, soda brands, energy drink brands, health drink brands, smoothie brands, milkshake brands, and/or the like) and/or specific to vending locations (e.g., specific to stores of a specific a franchise name). The first module 302 (and/or a related module) can advertise the availability of the branded drinks but restrict access to the recipes until approved by the brand. For example, the first module 302 can require a vending location to pay an upfront fee and/or royalties to access a branded recipe. In another example, the first module 302 can allow a brand to review an access request to control where their branded drinks are available and/or check for quality control at the vending locations requesting access. Additionally, or alternatively, the first module 302 can monitor customized recipes for imitations of branded recipes to help prevent vending locations from copying branded drinks after accessing them once.

The second module 304 can help generate menu and drink settings for a vending location. For example, the second module 304 can keep track of the required ingredients for recipes as a vending location builds a menu, prevent the vending location from selecting recipes requiring additional ingredients once they reach a limit on the ingredients the beverage robots can store, and/or suggest additional beverages based on the ingredients at the vending location (e.g., other beverages that can be created without additional ingredients). Additionally, or alternatively, the second module 304 can use information about the vending location (e.g., restaurant type, sales in a surrounding area, demographic information around the vending location, seasonal information, and/or the like) to suggest recipes for the menu. Purely by way of example, the second module 304 can recommend that a pizza restaurant stock ingredients for lemonade, sodas, sports drinks, and/or the like based on those beverages typically selling well with pizza. In another example, the second module 304 can recommend a vending location near a university to stock ingredients for coffee, energy drinks, and/or the like based on demographic information for the vending location. Still further, once a vending location has selected recipes for their beverage robot(s), the second module 304 can generate a menu (e.g., a user interface for a virtual menu) with the recipes and provide the menu to the vending location POS and/or the beverage robot.

The third module 306 can provide an order manager to one or more vending locations. The order manager can queue orders (or individual beverages from orders) to be produced by the beverage robot(s). For example, the order manager can determine which beverage robot in a café will be able to produce an order fastest based on existing queues at each beverage robot in the café, then add the order to the queue at the chosen beverage robot. In some embodiments, orders are scheduled based on estimated completion times and estimated pick-up times. For example, when a customer orders through an app on their phone, the order manager can estimate when they will arrive at the café and delay the production of their order until closer to the arrival time. As a result, the order will be fresher when picked up than if the order had been queued and produced when received. In another example, the order manager can receive a take-out/delivery order for a beverage from a first restaurant, determine that a second restaurant can provide the beverage to the customer sooner, and present the customer with the option to receive the beverage from the second restaurant. By producing the order from a recipe with a beverage robot, the customer can then receive the same drink (as customized to the first restaurant) from the second restaurant. Further, the first and second restaurants can expand their sales by making the beverages more convenient/quicker to receive. In yet another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive customizations and/or order changes. Further, because the order manager can track the status of an order through production, the order manager can allow a customer to seamlessly make changes to their order until the order is prepared by the beverage robot(s).

The fourth module 308 can provide a service dashboard for vending location personnel and/or personnel associated with the beverage robots. The service dashboard can provide a record of statistics and data from the beverage robots (e.g., past and scheduled maintenance, health status of beverage robots, cleaning status of beverage robots, usage of beverage robots, and/or the like). In a specific, non-limiting example, the service dashboard can show that one or more tubes in a beverage robot are locked, along with an error code explaining why they are locked (e.g., spoiled ingredients, required cleaning, connection malfunction, and/or the like). As a result, the service dashboard can allow personnel associated with the beverage robots to respond to inquiries from vending locations and/or guide them through correcting the error. Additionally, or alternatively, the service dashboard can allow vending location personnel to address issues without contact with other maintenance personnel. In some embodiments, the service dashboard in the fourth module 308 can communicate with one or more additional modules (e.g., the sixth module 312 discussed in more detail below) to provide information related to the health status of beverage robots, cleaning data related to the beverage robots, usage of the beverage robots, and/or the like.

The fifth module 310 can include an ingredient manager. The ingredient manager can receive SKU information for shipments to vending locations and ingredient packages (e.g., BIBs) as they are used by the beverage robots. The ingredient manager can use the SKU information to track ingredient consumption in vending locations. Additionally, or alternatively, the ingredient manager can track and/or identify ingredients from specific batches (e.g., to prompt the first module 302 to adjust a recipe for variations between batches, identify recalled batches, and/or the like). Further, the ingredient manager can track ingredient expiration dates (e.g., milk and other spoilable ingredients) and prompt vending locations to replace ingredients close to their expiration. Still further, the ingredient manager can receive information from one or more sensors in the beverage robots related to ingredients remaining in a package (e.g., dispensing information, weight measurements, volume measurements, and/or the like) to help track and manage inventory for a vending location. The ingredient manager can then prompt a vending location to replace (or plan to replace) empty packages in the beverage robots, order more packages as their inventory goes down, and/or the like. In some embodiments, the ingredient manager automatically manages inventory (e.g., tracks and orders inventory) for a vending location to make sure they are stocked on ingredients. In some such embodiments, the ingredient manager accounts for sales trends, sales forecasts, and/or the like while managing inventory. Purely by way of example, the ingredient manager can stock additional ingredients for cold beverages ahead of a heat wave in anticipation of increased sales to make sure the vending location has adequate inventory.

The sixth module 312 includes a robot operating rating system. The robot operating rating system can use data from beverage robots at a vending location to evaluate and/or grade the vending location. For example, the robot operating rating system can consider data related to cleaning cycles and cleaning times of the beverage robots, error codes and responses to error codes, employee certification and training, inventory management from vending locations, shelf-life management from vending locations, and/or the like. The data can then be used to generate food safety ratings, grade the operation of the beverage robots, improve quality control for the operation of the beverage robots, and/or the like. The sixth module 312 can then use the ratings to adjust maintenance schedules for the beverage robots (e.g., increase maintenance when vending locations do not respond well to error codes), adjust the operation of the beverage robots (e.g., prevent robots from dispensing spoiled ingredients), and/or provide the ratings to franchise owners and/or brands to help monitor the vending locations for quality control.

The seventh module 314 can provide a platform for brands/vending locations to market themselves and/or interact. For example, brands can create beverage recipes that they market through the seventh module. Vending locations can review available brands as they generate (or refresh) their menu offerings, then contract with the brands through the seventh module 314. Additionally, or alternatively, brands can contact vending locations through the seventh module to place their beverages in a variety of locations. Further, the seventh module 314 can communicate with various other modules on the platform 300. Purely by way of example, the seventh module 314 can communicate with the sixth module 312 to make ratings of vending locations available to brands as they decide whether to contract with a vending location. Similarly, the seventh module 314 can obtain sales data associated with branded drinks to provide the sales data to vending locations as they decide whether to work with a brand. As a result, the seventh module 314 can help increase transparency between brands and vending locations, increase quality control for branded beverages, and/or the like.

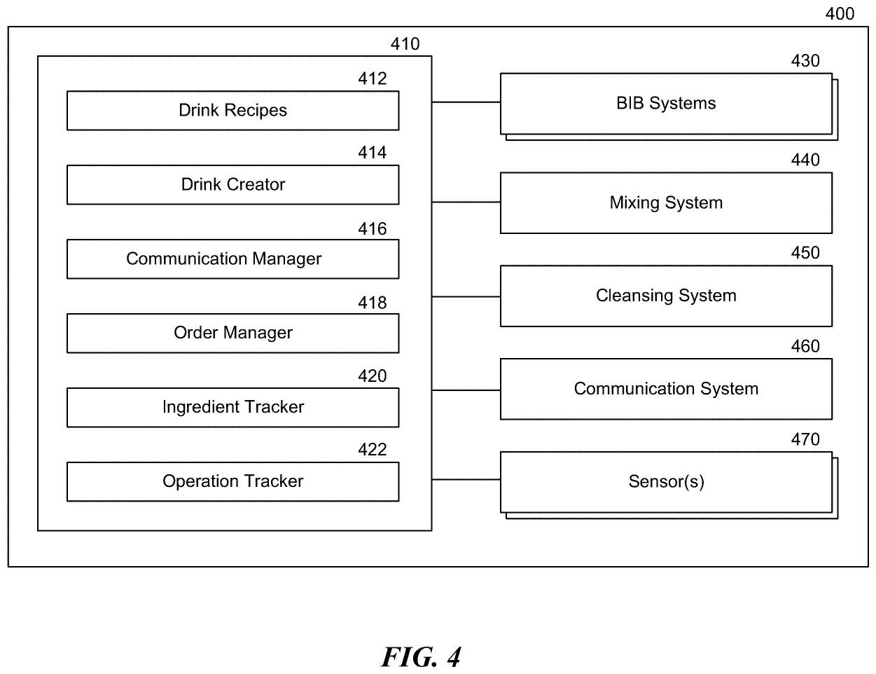

FIG. 4 is a block diagram of a subsystem 400 for a beverage robot in accordance with some embodiments of the present technology. The subsystem 400 can be deployed, for example, in the food/beverage robots 222 discussed above with respect to the environment 200 of FIG. 2. A processor and/or a storage component are not illustrated in FIG. 4 to avoid obscuring the illustrated components of the subsystem 400. However, one of skill in the art will understand that the subsystem 400 can include one or more processors and any suitable number of storage components to facilitate various operations of the subsystem 400 described herein.

As illustrated in FIG. 4, the subsystem 400 includes an operating platform 410 (“platform 410”) with one or more modules (six shown, referred to individually as first-sixth modules 412-422), as well as one or more BIB systems 430 (and/or other suitable ingredient containers), a mixing system 440, a cleansing system 450, a communication system 460, and one or more sensors 470.

The BIB systems 430 can store various concentrated ingredients related to beverage offerings from the subsystem 400. The mixing system 440 can receive and mix ingredients from the BIB systems 430 according to a recipe in a relatively short time (e.g., in less than a minute per beverage, less than 40 seconds per beverage, less than 30 seconds per beverage, and/or the like). In various embodiments, the mixing system 440 can include a blending component, shaking component, stirring component, emulsifying component, and/or any other suitable system to mix the ingredients according to the recipe. The cleansing system 450 can clean the mixing system 440, and/or any tubing and/or valves between the BIB systems 430 and the mixing system 440. The cleansing system 450 can be configured to operate between each beverage to avoid flavor contamination between beverages. Additionally, or alternatively, the cleansing system 450 can operate periodically to kill bacteria and/or build up in the tubing and/or valves.

The communication system 460 can operably couple the subsystem 400 to various other subsystems and/or platforms, such as other beverage robots, the POS system 224 of FIG. 2, and/or the platform 300 of FIG. 3. In various embodiments, the communication system 460 can include components configured to communicate over a shortrange wireless standard (e.g., a Bluetooth®, Zigbee®, Z-Wave®, Wi-Fi HaLow®, or any other suitable shortrange standard), communicate with a network over a wireless (or wired) internet connection (e.g., a WiFi connection or ethernet connection), and/or communicate with the network through a cellular internet connection (e.g., based on a 3G, 4G, LTE, 5G, 6G, or other standard).

The sensors 470 can be coupled to various components of the subsystem 400 to help monitor the operation of the beverage robot. For example, the sensors can include weight and/or volume sensors coupled to the BIB systems 430 to measure remaining ingredients in each BIB; temperature sensors in the BIB systems 430 to help monitor a freshness and/or status of ingredients; volumetric dispensing sensors to monitor the volume of ingredients provided to the mixing system 440; operating sensors coupled to the cleansing system 450 to monitor a frequency of cleansing; and/or the like. Additionally, or alternatively, the sensors 470 can include sensors that monitor connections between the BIB systems 430 and the mixing system 440 to make sure tubes, valves, and/or nozzles are properly connected and in good health; and/or other sensors to monitor a health condition of the beverage robot.

The platform 410 can be operably coupled to each of the BIB systems 430, the mixing system 440, the cleansing system 450, the communication system 460, and/or the sensors 470 to facilitate various operations of the beverage robot via the first-sixth modules 412-422 (and/or any other suitable modules). For example, the first module 412 can store drink recipes specific to the beverage robot, access the drink recipe library in the first module 302 of FIG. 3, and share drink recipes with other beverage robots (e.g., to allow the other beverage robots to prepare the recipe) and/or receive recipes from other beverage robots. Further, the first module 412 can communicate with a POS system and/or other user interface to share information on the beverages available in the subsystem 400.

The second module 414 includes a drink creator. The drink creator can allow a vending location to customize a drink recipe from the first module 412 (e.g., adjusting the portions of ingredients, adding or removing ingredients, changing an order the ingredients are added/mixed, and/or the like). Accordingly, the drink creator can allow the vending location to customize generic recipes to preferences of the vending location. Additionally, or alternatively, the drink creator in the second module 44 can communicate with a POS system and/or other user interface to allow a user (e.g., a customer) to customize a beverage to their preferences (e.g., to change milk types, remove an ingredient, add an ingredient, and/or the like).

The third module 416 can include a communication manager. The communication manager can work with any of the modules in the platform 410 and/or any of the other components of the subsystem 400 to communicate outside of the subsystem 400. In a specific, non-limiting example, the communication manager can help direct communications between the first module 412 and a drink library in the remote system 210 of FIG. 2 to move drink recipes therebetween. In another specific, non-limiting example, the communication manager can send data from the sensors 470 to the robot operating rating system in the sixth module 312 discussed above with reference to FIG. 3.

The fourth module 418 can include an order manager. Similar to the order manager discussed above with reference to FIG. 3, the order manager can queue orders (or individual beverages from orders) to be produced by the beverage robot associated with the subsystem 400 and/or various other beverage robots in communication with the subsystem 400. For example, the order manager can queue orders at beverage robots with shorter wait times and the necessary ingredients. Additionally, or alternatively, the order manager can queue orders to sync estimated completion times with estimated pick-up times. In another example, the order manager can track the status of an order throughout the production process (e.g., by monitoring the position in the queue(s)) to provide customers with a real-time, accurate prediction of when their order will be complete. The increased transparency can increase customer satisfaction, particularly during busy times at a vending location. In yet another example, the order manager can receive order changes after an order is queued, modify the order in the queue, then produce the order. The on-site accessibility of the order manager can increase a speed of the order management and/or allow a vending location to override order queuing directly from the subsystem 400.

The fifth module 420 can include an ingredient tracker. Similar to the ingredient manager discussed above with reference to FIG. 3, the ingredient tracker can help monitor a volume of ingredients remaining in each of the BIB systems 430, track an age of the ingredients in the BIB systems 430, and/or the like. As a result, the ingredient tracker can notify a vending location when one of the BIB systems 430 needs to be replaced or will need to be replaced soon. Additionally, or alternatively, the ingredient tracker can help monitor overall volumes of ingredients used during a relevant time period to identify popular (or unpopular ingredients). The information can be useful, for example, in managing the vending location's inventory and orders related to various ingredients. Still further, the ingredient tracker can help identify ingredients approaching their expiration date, prompt the vending location to change the ingredients, and/or prevent the subsystem 400 from vending expired ingredients.

The sixth module 422 can include an operation tracker. The operation tracker can be communicably coupled to the order manager in the fourth module 418, the BIB systems 430, the mixing system 440, the sensors 470, and/or any other suitable components of the subsystem 400 to record operations thereof. As a result, the operation tracker can help track drink sales, identify cleaning and/or maintenance patterns, ensure the BIB systems 430 are properly installed, track how often the BIB systems 430 are swapped, whether the correct BIB systems 430 are swapped, whether the mixing system 440 is properly cleaned between orders, and/or the like. The information can be used by the vending location to help improve sales, identify popular (or unpopular) beverages, improve quality control, monitor staff operations, and/or the like. Additionally, or alternatively, the information can be used to schedule (or predict) maintenance for the beverage robot. Additionally, or alternatively, the information can be shared with an external system, such as the service dashboard and/or robot operating rating systems discussed above with reference to FIG. 3.

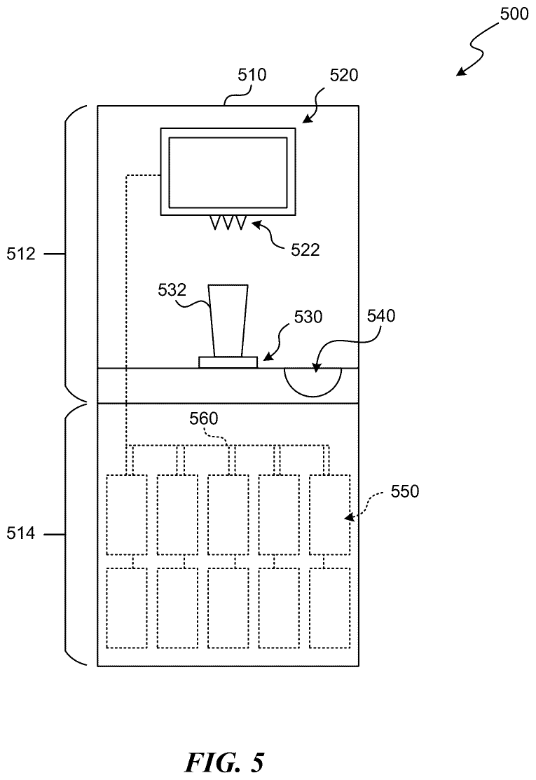

FIG. 5 is a schematic front view of a beverage robot 500 configured in accordance with some embodiments of the present technology. In the illustrated embodiment, the beverage robot 500 includes a housing 510 having an upper portion 512 and a lower portion 514 fluidly coupled to the upper portion 512. The upper portion 512 (sometimes also referred to as a “mixing portion,” an “active blending portion,” and/or the like) can include a dispensing head 520 positioned above a mixing driver 530 and a mixing container 532. The dispensing head 520 can include one or more nozzles 522 (three shown in the illustrated embodiment) that are positioned to dispense ingredients (e.g., concentrated juices, coffee, tea, syrups, water, sparkling water, and/or the like) into the mixing container 532. The mixing driver 530 can include a blender, shaker, emulsifier, and/or any other suitable component. The mixing container 532 can include a detachable container, an open container (e.g., an open cup), a closable container, and/or any other suitable component. As further illustrated in FIG. 5, the upper portion 512 can also include a cleansing system 540 adjacent to the mixing driver 530. The cleansing system 540 can include a glass rinser/washer that is configured to dispense water and/or a cleaning solution into the mixing container 532 and a draining component (e.g., a sink) to receive and carry used water and/or cleaning solution away from the mixing container 532. In some embodiments, the cleansing system 540 includes an automatic scrubber positioned to scrub the mixing container over the draining component.

During operation, the beverage robot 500 can dispense one or more ingredients through the dispensing head 520 and into the mixing container 532. The beverage robot 500 can then operate the mixing driver 530 to mix, blend, emulsify, and/or otherwise combine the ingredients in the mixing container 532. The beverage robot 500 can then repeat the process to dispense one or more additional ingredients and combine ingredients in the mixing container 532 according to a recipe for a current beverage. Additionally, or alternatively, the beverage robot 500 can dispense one or more ingredients to top the current beverage. A user of the beverage robot 500 (e.g., staff at a restaurant) can then pour the beverage out of the mixing container 532 into a container for the customer (e.g., a cup, disposable cup, bottle, carafe, bowl, and/or any other suitable container). Once empty, the user can position the mixing container 532 over the cleansing system 540 and operate the cleansing system 540 to clean and/or sanitize the mixing container 532. The user can then reset the mixing container 532 on the mixing driver 530 to prepare the beverage robot 500 for the next beverage.

As illustrated in FIG. 5, the lower portion (sometimes referred to as a “storage portion,” a “refrigeration portion,” and/or the like) can store one or more ingredient packages 550 (e.g., the BIB systems 430 discussed above with reference to FIG. 4). Each of the ingredient packages 550 can contain a concentrated ingredient that is used in one or more recipes that the beverage robot 500 can prepare. The ingredient packages 550 can be independently accessible and/or replaceable, allowing the user to swap packages as supply in any of the ingredient packages 550 runs low. In some embodiments, the lower portion 514 is refrigerated to keep the ingredient packages 550 at or below a predetermined temperature. In some embodiments, the lower portion 514 includes one or more sub-portions. A first sub-portion can be refrigerated to preserve perishable ingredients while a second sub-portion is not refrigerated (or heated) and stores non-perishable ingredients. The second sub-portion can be useful, for example, to store ingredients that become too viscous to adequately dispense when cooled.

As further illustrated in further illustrated in FIG. 5, each of the ingredient packages 550 can be fluidly coupled to the dispensing head 520 through vending lines 560. The vending lines 560 can include various components (e.g., valves, tubing connections, pumps, volumetric meters, pre-mixing components, and/or the like) to quickly provide ingredients to the dispensing head 520 with accurate volumetric amounts. In some embodiments, the vending lines 560 include a cleansing system configured to clean one or more of the tubing connections between beverages to reduce (or eliminate) cross-contamination. Further, in various embodiments, the lower portion 514 can be positioned directly beneath the upper portion 512 and/or can be separated from and fluidly coupled to the upper portion 512. In embodiments where the lower portion 514 is separated from the upper portion 512, the beverage robot 500 can include longer vending lines 560 and/or additional compression components to move ingredients between the lower portion 514 and the dispensing head 520.

### Specific Examples of Mesh Networks of Beverage Robots and Methods for Operating the Mesh Networks in Accordance With Embodiments of the Present Technology

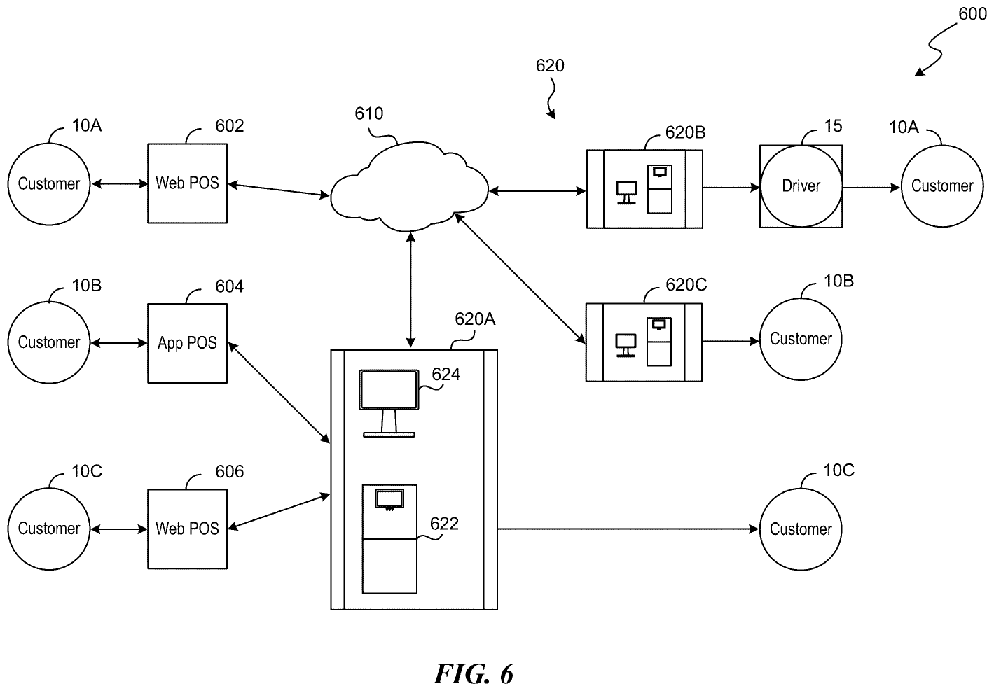

FIG. 6 is a schematic diagram of a mesh network 600 with a plurality of beverage robots in different geographic locations configured in accordance with some embodiments of the present technology. As illustrated in FIG. 6, the mesh network 600 can allow, for example, a customer to receive a beverage from a second vending location (e.g., a store closer to them) after ordering from a first vending location (e.g., a favorite restaurant). While the first and second vending locations may offer different selections of beverages and/or have different recipes for beverages of a specific type (e.g., differing recipes for a lemonade), the mesh network 600 can manage and share ingredient and recipe information between the stores to allow the second store to produce the beverage with the same profile, ingredients, quality, and/or the like as a first vending location.

In the illustrated embodiment, the mesh network 600 includes a remote system 610 and a plurality of vending locations 620 (three illustrated in FIG. 6, referred to individually as “first-third vending locations 620A-620C,” sometimes also referred to herein as “stores”). The remote system 610 can be generally similar (or identical) to the remote systems 110, 210 discussed above with reference to FIGS. 1 and 2. Similarly, the vending locations 620 can each be generally similar (or identical) to the vending locations 120, 220 discussed above with reference to FIGS. 1 and 2. For example, as best illustrated with respect to the first vending location 620A in FIG. 6, the vending locations 620 can each include one or more beverage robots 622 (one illustrated in FIG. 6) and a POS system 624 communicably coupled to the beverage robot(s). Further, each of the beverage robots 622 can include a subsystem generally similar (or identical) to the subsystem 400 discussed above with reference to FIG. 4.

Still further, the remote system 610 can include one or more server computing devices that implement an operating platform generally similar (or identical) to the platform 300 discussed above with reference to FIG. 3 to help manage, control, and/or direct operations at each of the vending locations 620. For example, the remote system 610 can be communicably coupled to the first vending location 620A, the second vending location 620B, and the third vending location 620C. Accordingly, the remote system 610 can help manage orders throughout the mesh network 600, various specific examples of which are illustrated in FIG. 6. More specifically, FIG. 6 illustrates three customers (referred to individually as first-third customers 10A-10C) that interact with the mesh network 600 to order beverages from a menu at the first vending location 620A and ultimately receive the beverages from a variety of different locations.

For example, the first customer 10A can access the menu at the first vending location 620A through a first web-based POS 602, such as a website coupled to (or hosted by) the remote system 610, a third-party ordering platform (e.g., Google®, Square®, DoorDash®, Grubhub®, Uber Eats®, Seamless®, Postmates®, and/or the like), and//or the like. When the first customer 10A submits an order for one or more beverages through the web-based POS 602, the web-based POS 602 communicates the order to the remote system 610. As discussed in more detail below with respect to FIGS. 7-11, the remote system can then check whether the first customer 10A can receive the beverage(s) in their order earlier (e.g., in less time, at an earlier time, and/or the like) from the second vending location 620B and/or the third vending locations 620C and present the earlier option(s) to the first customer 10A.

The check can include determining whether the second vending location 620B and/or the third vending location 620C have the ingredients necessary to prepare the beverage(s) in the order, determining an estimated completion time for the beverage(s) in the order at each of the first-third vending locations 620A-620C (e.g., based on an existing queue in the beverage robots 622 at each of the first-third vending locations 620A-620C), determining an estimated travel time and/or time of arrival for the first customer 10A at each of the first-third vending locations 620A-620C (e.g., based on a geographic location of the first customer 10A compared to each of the first-third vending locations 620A-620C), determining an estimated travel time and/or time of arrival for a driver (e.g., food delivery staff) at each of the first-third vending locations 620A-620C, and/or the like.

The remote system 610 can then receive a selection of which vending location should prepare the beverage(s) in the order and send the order to the selected vending location. In the illustrated example, the first customer 10A elects to have a driver 15 associated with the order (e.g., a delivery service driver) pick up the order from the second vending location 620B. Accordingly, the remote system 610 can send the order to the second vending location 620B. The second vending location 620B can then prepare each of the beverage(s) in the order for pick up from the driver 15. The driver 15 can then pick up the beverage(s) and deliver them to the first customer 10A.

In another example, as further illustrated in FIG. 6, the second customer 10B can access the menu at the first vending location 620A through an App-based POS 604 that is communicatively coupled to the remote system 610 and/or the first vending location 620A. The App-based POS 604 can be a smartphone (or other smart device) app specific to the first vending location 620A, an app hosted by the remote system 610, and/or a third-party app (e.g., Google®, Square®, DoorDash®, Grubhub®, Uber Eats®, Seamless®, Postmates®, and/or the like). When the second customer 10B submits an order for one or more beverages, the App-based POS 604 can send the order to the first vending location 620A. The first vending location 620A can then forward the order to the remote system 610. Additionally, or alternatively, the App-based POS 604 can send the order directly to the remote system 610. Similar to the discussion above, once the remote system receives the order from the second customer 10B, the remote system 610 can check for an earlier (e.g., quicker, faster, and/or the like) reception time at the second and third vending locations 620B, 620C, present the earlier options to the second customer 10B, receive a selection, and forward the order to the selected location. In the illustrated example, the second customer 10B selected the third location 620C and will receive the beverage(s) in their order directly from the third vending location 620C.

In yet another example illustrated in FIG. 6, the third customer 10C can access the menu at the first vending location 620A through a second Web-based POS 606 that is communicatively coupled to the remote system 610 and/or the first vending location 620A. The second Web-based POS 606 can be a website hosted by and/or specific to the first vending location 620A (e.g., a restaurant's website) with an integrated menu and ordering interface. Further, the second Web-based POS 606 can be coupled to the remote system 610 via a network connection. Accordingly, when the third customer 10C submits an order for one or more beverages, the order is received at the first vending location 620A through the second Web-based POS 606. The first vending location 620A (e.g., directly and/or automatically through the second Web-based POS 606) can then forward the order to the remote system 610. Similar to the discussion above, once the remote system receives the order from the third customer 10C, the remote system 610 can check for an earlier reception time at the second and third vending locations 620B, 620C, present the earlier options to the third customer 10C, receive a selection, and forward the order to the selected location. In the illustrated example, the third customer 10C selected the first vending location 620A and received the beverage(s) in their order directly from the first vending location 620A.

Each of the vending locations 620, however, can have customized recipes for the beverages on their menu (e.g., recipes specific to each individual vending location). Purely by way of example, the first vending location 620A can have a first recipe for lemonade that includes 10% lemon juice concentrate, 10% simple syrup concentrate, 10% carbonated water, 30% regular water, and 40% ice; the second vending location 620B can have a second recipe for lemonade that includes 10% lemon juice concentrate, 5% simple syrup concentrate, 45% regular water, and 40% ice; and the third vending location 620C can have a third recipe for lemonade that includes 10% lemon juice concentrate, 5% simple syrup concentrate, 5% strawberry juice concentrate, 50% regular water, and 30% ice. As a result, the lemonade from the first-third vending locations 620A-620C will taste different when prepared by the beverage robots 622 according to the recipe at the first-third vending locations 620A-620C. Thus, for example, if the second vending location 620B prepares the beverage(s) in the order from the first customer 10A, the beverage(s) may taste different from expectations from the first customer 10A when they submitted the order. Additionally, or alternatively, the vending locations 620 can have different menus altogether while sharing one or more common ingredients. For example, the second vending location 620B may not sell lemonade at all while having the lemon juice concentrate, simple syrup concentrate, carbonated water, and regular water required to make the lemonade. In this example, the second vending location 620B has no recipe to prepare lemonade, much less a recipe that will taste identical to the lemonade prepared according to the recipe at the first vending location 620A.

To address this issue, the remote system 610 can store (or access) the recipes for each of the beverages offered by the vending locations 620 and send the relevant recipe to the vending locations 620 when sending orders. For example, when the remote system 610 sends the order from the first customer 10A to the second vending location 620B, the remote system 610 can retrieve the recipe(s) for each of the beverage(s) in the order specific to the first vending location 620A and send the recipe(s) to the beverage robots in the second vending location 620B. As a result, the beverage robot 622 in the second vending location 620B can prepare the beverage(s) with a flavor profile that is similar (or identical) to the beverage(s) as prepared by the beverage robot 622 at the first vending location 620A. Further, because the beverage(s) are prepared by the beverage robot 622, the mesh network 600 does not require staff at each of the vending locations 620 to be trained to prepare all of the beverage offerings in the mesh network 600 and/or follow recipe directions to create the beverages. As a result, for example, the mesh network 600 can enable the beverage offerings from the first vending location 620A to be offered at the second and third vending locations 620B, 620C with consistency in the taste and other qualities. In turn, the expansion of locations can allow the customers to increase their options to receive beverages according to the recipes at their preferred vending locations, which can increase the speed at which the customers receive their orders and/or convenience for customers to receive their preferred beverages.

FIG. 7 is a flow diagram of a process 700 for operating a mesh network with a plurality of beverage robots in accordance with some embodiments of the present technology. The mesh network can be generally similar to the mesh network 600 discussed above with reference to FIG. 6. Further, it will be understood that the process 700 can be executed by any suitable computing devices in the mesh network. For example, the process 700 can be executed by one or more computing devices in the remote system 610 of FIG. 6 implementing the platform 300 discussed above with reference to FIG. 3; a computing device with the subsystem 400 discussed above with reference to FIG. 4, such as the beverage robot 622 and/or the POS system 624 of FIG. 6; and/or the like. Additionally, or alternatively, although discussed herein in the context of being executed entirely within a single component (e.g., entirely within the remote system 610 of FIG. 6), it will be understood that a first subset of the process 700 can be executed by a different computing device than a second subset of the process 700.

The process 700 begins at block 702 with receiving an order for one or more beverages from a first store (e.g., a first vending location). As discussed above, the order can be received from a variety of sources, such as various web-based platforms, app-based platforms, and/or the like. In some embodiments, the order is received at a remote system directly from the customer associated with the order. In some embodiments, the order is received at the remote system from another platform (e.g., from the first store, from a third-party ordering platform, and/or the like).

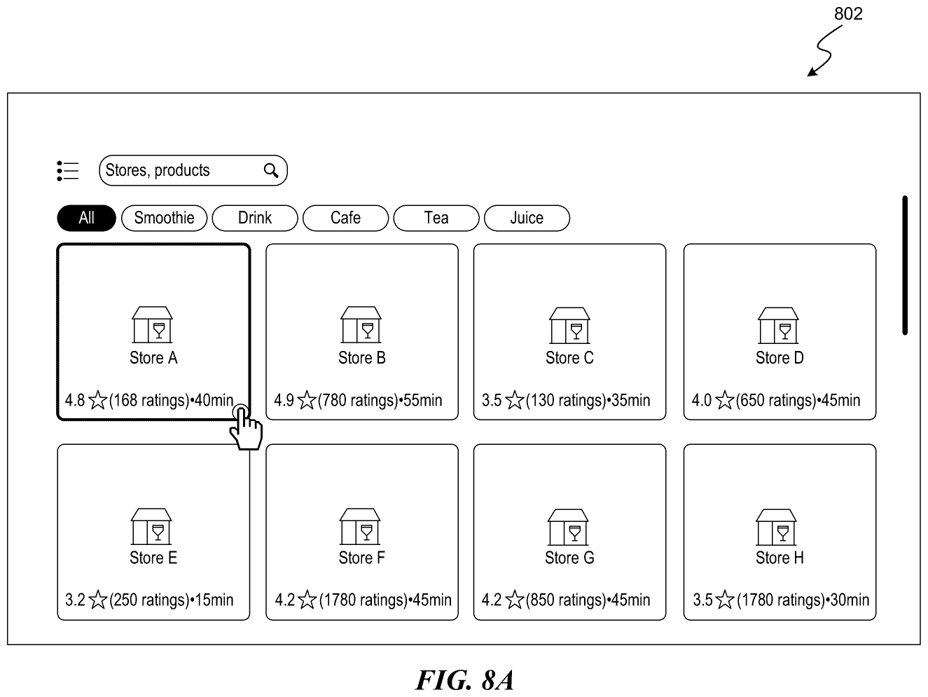

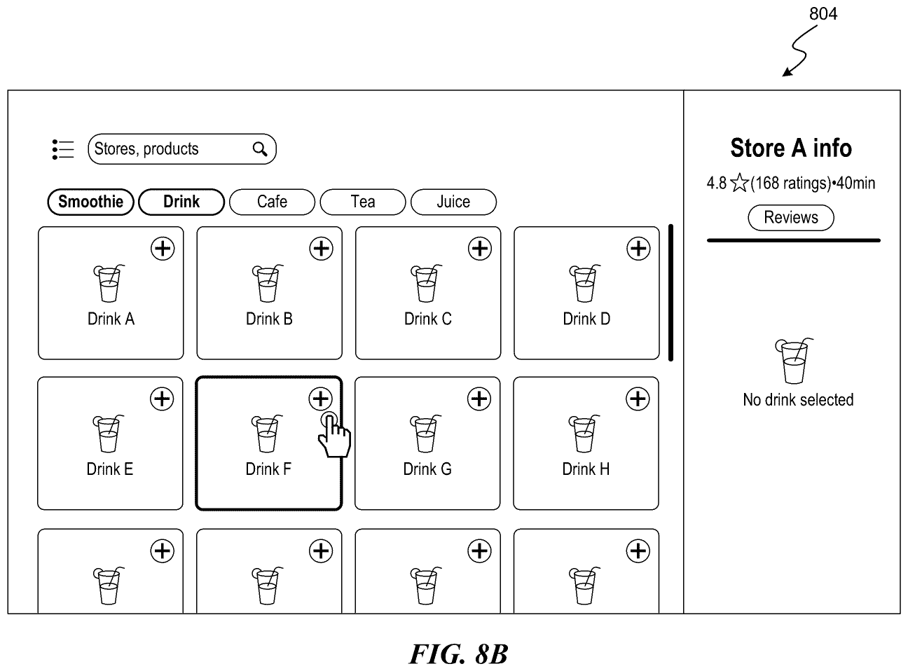

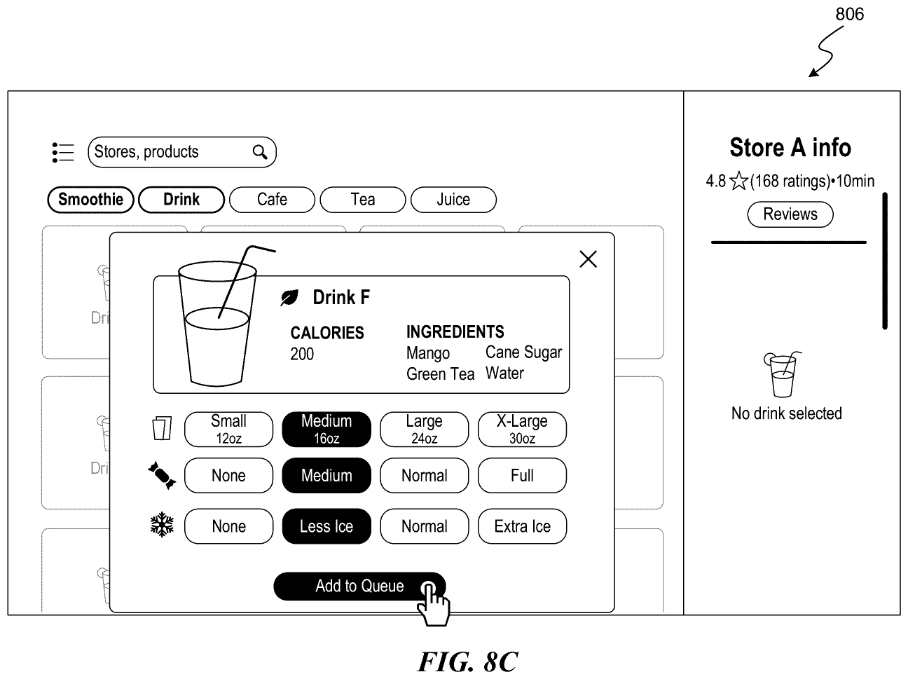

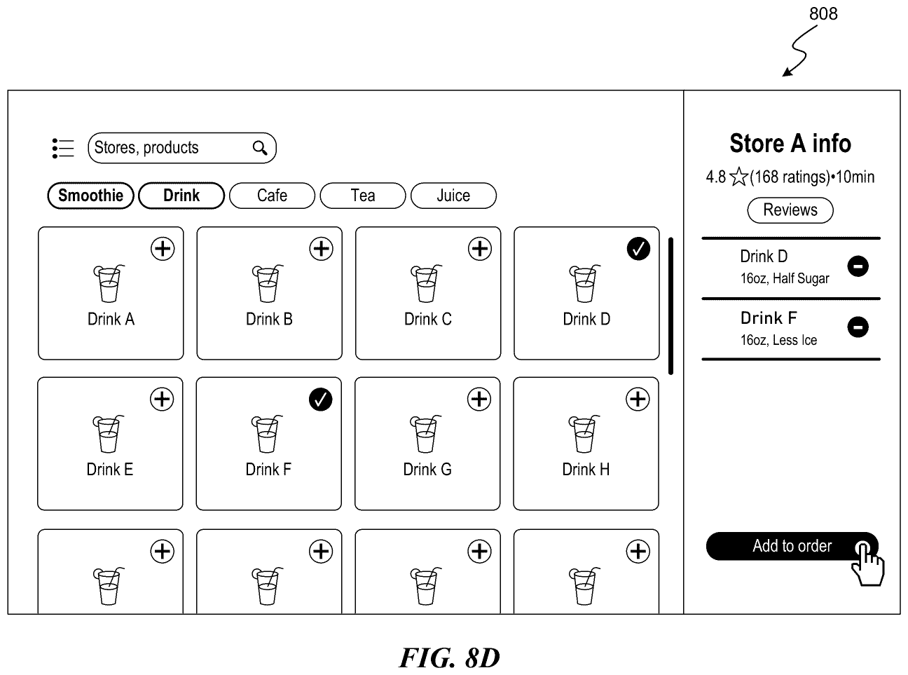

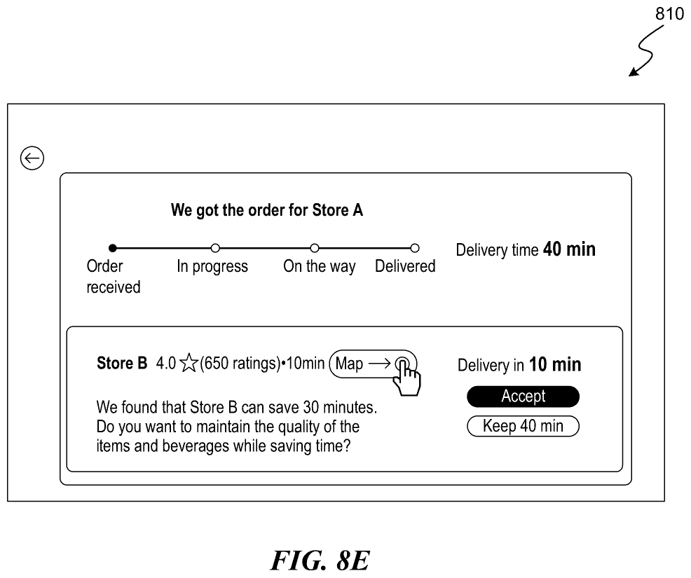

Purely by way of example, FIGS. 8A-8D are wireframe diagrams illustrating examples of user interfaces that the user can interact with to submit an order for one or more beverages. More specifically, FIG. 8A illustrates a user interface 802 that allows the user to select a store and submit an order to the selected store. FIG. 8B illustrates an example of a user interface 804 that allows the user to review a beverage menu at the selected store. From the user interface 804 illustrated in FIG. 8B, the user can select any of the drinks to review additional information on the beverage. FIG. 8C illustrates an example of a user interface 806 resulting from the selection of Drink F in the user interface 804 of FIG. 8B. As illustrated in FIG. 8C, the user interface 806 can display nutritional information, ingredients, size offerings, customization offerings, a graphic of the beverage, and/or the like. Once the user has selected a size and/or made any customizations they want, the user can add the drink to their cart. FIG. 8D illustrates an example of a user interface 808 that allows the user to review the beverage menu, their cart, and/or any customizations to the beverages in their cart before finalizing and submitting their order. Once the user submits, the order (e.g., with Drink A and Drink F) is received by the process 700.

Returning to the description of FIG. 7, at block 704, the process 700 includes checking the mesh network for one or more second stores that have beverage robots with the ingredients necessary to produce the order (e.g., prepare each beverage in the order). Each of the beverage(s) in the order is associated with a recipe that requires one or more ingredients (e.g., concentrated juices, syrups, coffee, tea, and/or the like; water; sparkling and/or carbonated water; milk and/or milk alternatives; and/or the like). Further, the recipes can be standard within the mesh network or specific to the first store (e.g., a recipe customized at the first store). Accordingly, the check at block 704 can begin by retrieving the recipe for each of the beverage(s) in the order to compile a list of the ingredients required to produce the order. In various embodiments, the recipes can be retrieved from one or more databases at the remote system and/or retrieved from the first store (e.g., by querying the beverage robot(s), computing devices, and/or the like).

The check at block 704 can then include checking the ingredients available at beverage robots in each store in the mesh network to identify any additional stores in the mesh network that can prepare each of the beverages in the order. To be available to produce each beverage, the store must have, for each beverage in the order, at least one beverage robot that has access to the ingredients required for the beverage. As a result, for example, a store can be unavailable despite having all of the ingredients in the list if the ingredients for one of the beverages in the order are split between beverage robots at the store. Similar to the retrieval of the recipes, the check can include retrieving the information on each store from one or more databases at the remote system and/or querying each of the stores in the mesh network for the information.

At decision block 706, if no second stores were identified in block 704, the process 700 continues to block 708 to prepare the beverage(s) in the order at the first store. For example, at block 708, the process 700 includes sending the order to the first store (e.g., to the POS system in the first store and/or to one or more of the beverage robots in the first store), causing the beverage robot(s) in the first store to produce the order. Conversely, if at least one second store was identified in block 704, the process 700 continues to block 710.

At block 710, the process 700 includes determining an estimated reception time from each of the stores (e.g., the first store and each of the second stores identified at block 704). The reception time is the time a customer will actually receive the order from each of the stores based on the time it will take a store to produce the order and/or the time it will take the customer to arrive at the store to retrieve the order. That is, the reception time from each individual store can be based on a calculated (or estimated) travel time between the customer and the individual store, a calculated travel time between a delivery person and the individual store, a calculated travel time for a delivery person between the individual store and the customer, a queue at the individual store, an estimated completion time for the order at the individual store, and/or the like.

Accordingly, for example, the process 700 at block 710 can include determining an estimated time of arrival for the customer at each of the stores as well as the estimated time of completion at each of the stores. Determining the estimated time of arrival can include receiving information about the customer's current location (e.g., Global Positioning System (GPS) signals from a user device associated with the user) and/or a mode of travel for the customer (e.g., walking, biking, driving, riding transit, and/or the like). The process 700 can then generate a route to each of the stores and estimate a travel time associated with the route. In some embodiments, the process 700 can generate multiple routes (and estimated travel times) associated with different options for travel to each of the stores. Determining the estimated time of completion can include retrieving information related to a queue at each of the stores and/or related information (e.g., planned/predicted downtime for cleaning, maintenance, ingredient refills, and/or the like). The queue can be specific to each of the beverage robots that are available to prepare beverages in the order. The process 700 can then use the queue (and related information) to predict the completion time for the order. In some embodiments, the estimated completion time is based on an average preparation time per beverage (e.g., 20 seconds per drink, 30 seconds per drink, 40 seconds per drink, 1 minute per drink, and/or the like). In some embodiments, the estimated completion time is based on preparation times specific to the beverages in the queue.

Once the process 700 has identified the estimated time of arrival and the estimated completion time, the process 700 can then identify the later of the two as the estimated reception time. In a specific, non-limiting example, the first store can be a 15-minute walk away with an 8-minute estimated time of completion; a second store can be a 2-minute walk away with a 20-minute estimated time of completion; and a third store can be a 5-minute walk away with a 5-minute estimated time of completion. In this specific example, the reception time at the first store would be 15 minutes, the reception time at the second store would be 20 minutes (e.g., with the customer waiting for 18 minutes after (or before) they walk), and the reception time at the third store would be 5 minutes.

In another example, the process 700 at block 710 can include determining the estimated time of completion at each of the stores, an estimated time of arrival for a delivery person at each of the stores, and an estimated delivery time for the delivery person between each of the stores and the customer's location. The process 700 can then identify the later time between the estimated completion time and the estimated time of arrival for the delivery person at the store and add that to the estimated delivery time to generate the estimated reception time. In a specific, non-limiting example, the first store can be a 5-minute drive from a delivery person with an 8-minute estimated time of completion and a 10-minute drive from the customer; and a second store can be a 2-minute drive from the delivery person with a 10-minute estimated time of completion and an 6-minute drive from the customer. In this specific example, the reception time from the first store would be 18 minutes while the reception time from the second store would be 16 minutes.

At block 712, the process 700 includes checking for a faster reception time (e.g., quicker, earlier, and/or the like) than the first store based on the reception times determined at block 710. In the walking scenario discussed above, for example, the process 700 at block 712 can compare the reception time at the first store to the reception time at the second and third stores and determine that the third store has a faster reception time. Accordingly, the process 700 can identify the third store as a faster option while discarding the second store.

At decision block 714, if no faster time is identified in block 712, the process 700 continues to block 716 to prepare the beverage(s) in the order at the first store. For example, similar to the discussion above, the process 700 at block 716 can include sending the order to the first store to cause the beverage robot(s) in the first store to produce the order. Conversely, if at least one store with a faster reception time was identified in block 712, the process 700 continues to block 718.

At block 718, the process 700 includes presenting one or more of the faster stores to the customer associated with the order, allowing the customer to choose (e.g., select) any of the faster stores or elect to receive their order from the first store. The presentation can be accomplished in the same user interface that received the order (e.g., a web-based platform, an app-based platform, and/or the like). For example, FIG. 8E is a wireframe diagram illustrating an example of a user interface 810 that the user can interact with to review the presentation of one or more faster options (one illustrated in FIG. 8E). Further, as illustrated in FIG. 8E, the presentation in the user interface 810 can provide information about the faster store(s) to the customer while they review, such as the location of the faster store(s), an indication of how much time they can save, the estimated reception time at the first store and each of the faster store(s), reviews and/or ratings for the faster store(s), and/or the like.

Returning to the description of FIG. 7, at decision block 720, if the customer declines the faster store(s) (e.g., elects to receive their order from the first store), the process 700 moves to block 722 to prepare the beverage(s) in the order at the first store. For example, similar to the discussion above, the process 700 at block 722 can include sending the order to the first store to cause the beverage robot(s) in the first store to produce the order. Conversely, if the customer selects one of the faster store(s) (e.g., accepts one of the option(s)) that were presented at block 718, the process 700 continues to block 724.

At block 724, the process 700 includes sending the order and recipes associated with each of the beverage(s) in the order to the selected store. As a result, the process 700 can cause the beverage robot(s) in the selected store to produce the order. Further, by sharing the recipe for each of the beverage(s) in the order, the process 700 can cause the beverage robots in the selected store to prepare the beverage(s) with the same flavor profile and/or other characteristics as if the beverage(s) were prepared by the first store. For example, rather than using a recipe for lemonade at the selected store, the beverage robots in the second store will use the first store's recipe for lemonade, allowing the customer to receive the beverage(s) with the flavor profile (and other characteristics) that they are expecting.

In various embodiments, the process 700 at block 724 (or after block 724) can also include receiving an acknowledgment (ACK) notification from the selected store, storing a record of the order and the selected store, storing a record of the ACK notification, and/or the like. The records can allow the customer to view a confirmation of their order and/or a real-time status related to their order (e.g., based on a queue at the selected restaurant). Additionally, or alternatively, the record can allow the mesh network (e.g., under the control of the remote system) to split various aspects of the order, such as costs associated with producing the beverages and/or maintaining the beverage robots, sales from the order, profits from the order, reviews and/or ratings associated with the beverages in the order, and/or the like.

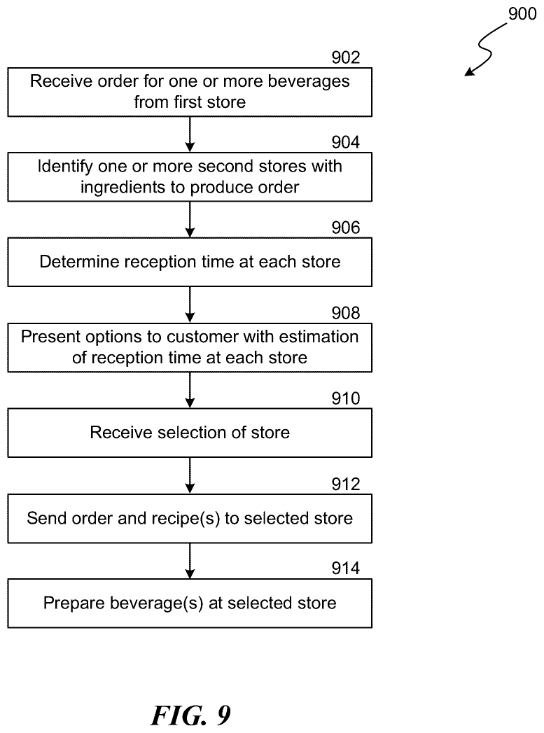

Although the blocks 702-724 of the process 700 are discussed and illustrated in a particular order, the process 700 illustrated in FIG. 7 is not so limited. For example, various steps of the process 700 can be performed in a different order. In these and other embodiments, any of the blocks 702-724 of the process 700 can be performed before, during, and/or after any of the other blocks 702-724 of the process 700. In a specific, non-limiting example, all or a subset of block 718 can be executed before a subset of blocks 710-714 to present a first faster store while checking for one or more additional faster stores. Moreover, a person of ordinary skill in the relevant art will recognize that the illustrated process 700 can be altered and still remain within these and other embodiments of the present technology. For example, the process 700 can be modified in view of any of the processes discussed below with reference to FIGS. 9-13.

FIG. 9 is a flow diagram of a process 900 for operating a mesh network with a plurality of beverage robots in accordance with some embodiments of the present technology. Similar to the process discussed above with reference to FIG. 7, the process 900 can be executed by any suitable computing device (or combination of computing devices) in a mesh network of the type discussed above. Purely by way of example, the process 900 can be executed by one or more computing devices in the remote system 610 of FIG. 6 implementing the platform 300 discussed above with reference to FIG. 3; a computing device with the subsystem 400 discussed above with reference to FIG. 4, such as the beverage robot 622 and/or the POS system 624 of FIG. 6; and/or the like. Further, although discussed herein in the context of being executed entirely within a single component (e.g., entirely within the remote system 610 of FIG. 6), it will be understood that a first subset of the process 900 can be executed by a different computing device than a second subset of the process 900.

Further, while generally similar to the process 700 discussed above with reference to FIG. 7, the remote system can execute the process 900 to present additional options to the user in response to every order (e.g., rather than just presenting one or more faster options). Including the additional options can allow, for example, the user to select a slower option that is on their way to another destination (e.g., and therefore faster and/or more convenient for the user overall).

The process 900 begins at block 902 by receiving an order for one or more beverages from a first store. Similar to the discussion above, the order can be received from a variety of sources, such as various web-based platforms, app-based platforms, and/or the like. In some embodiments, the order is received at a remote system directly from the customer associated with the order. In some embodiments, the order is received at the remote system from another platform (e.g., from the first store, from a third-party ordering platform, and/or the like).

At block 904, the process 900 includes checking for and identifying one or more second stores that have the ingredients necessary to produce the order. Similar to the discussion above, the process 900 at block 904 can include retrieving the recipe for each of the beverage(s) in the order to compile a list of the ingredients required to produce the order and checking the ingredients available at beverage robots in each store in the mesh network to identify the second stores in the mesh network that can prepare each of the beverages in the order.

At block 906, the process 900 process includes determining a reception time at each of the stores (e.g., the first store and each of the second stores identified at block 904). Similar to the discussion above, the reception time from each individual store can be based on a calculated (or estimated) travel time between the customer and the individual store, a calculated travel time between a delivery person and the individual store, a calculated travel time for a delivery person between the individual store and the customer, a queue at the individual store, an estimated completion time for the order at the individual store, and/or the like. Accordingly, for example, the process 900 at block 906 can include calculating a travel time between the customer and each of the stores, determining an estimated time of arrival for the customer at each of the stores based on the calculated travel time, and estimating the time of completion at each of the stores.

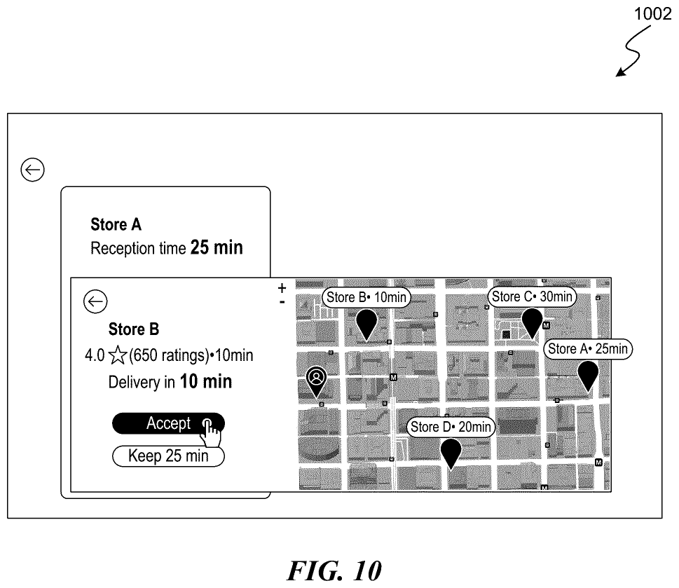

At block 908, the process 900 includes presenting each of the options to the customer with the estimated reception time for each option. At block 910, the process 900 includes receiving a selection of a store (e.g., a selection of one of the options). The presentation and selection processes can be accomplished in the same user interface that received the order (e.g., a web-based platform, an app-based platform, and/or the like). For example, FIG. 10 is a wireframe diagram illustrating an example of a user interface 1002 that the user can interact with to review each of the options for their order (four illustrated in FIG. 10 as Stores A, B, C, and D). Further, as illustrated in FIG. 10, the presentation in the user interface 1002 can provide information about each of the options, such as the location of each of the stores, the location of each of the stores relative to the user's current location (e.g., via the map in the user interface 1002), reviews and/or ratings for the faster store(s), suggested routes for each of the stores, and/or the like. While the user reviews options, the user interface 1002 also allows the user to select and confirm which of the options they prefer (e.g., selecting Store B or keeping with Store A). As further illustrated in FIG. 10, the options presented are not necessarily all faster than the first store (e.g., Store A). Purely by way of example, Store C is presented as an option in the user interface 1002 despite the later reception time. As a result, the process 900 of FIG. 9 can provide the user with a wider variety of options, allowing them to select the store that produces their order based on additional considerations. Purely by way of example, as illustrated in FIG. 10, Store C can be adjacent to a metro station that the user commutes through. Accordingly, the user may prefer Store C, despite the slower reception time based on the convenience to their commute route. In another example, one or more of the stores can have a promotional deal (e.g., a discount, reward points, coupon and/or other reward) that is presented to the user. Accordingly, the user may prefer to accept a slower reception time to take advantage of the promotional deal.

Returning to the description of FIG. 9, once the user selects a store, the process 900 can include sending the order and a recipe for each of the beverage(s) in the order to the selected store at block 912. As a result, the process 900 can cause the beverage robot(s) in the selected store to produce the order. Further, by sharing the recipe for each of the beverage(s) in the order, along with any modifications to the beverage(s), the process 900 can cause the beverage robots in the selected store to prepare the beverage(s) with the same flavor profile and/or other characteristics as if the beverage(s) were prepared by the first store. At block 914, the process 900 includes preparing the beverage(s) at the selected store. The preparation can be completed by instructing the beverage robots based on the recipe for each of the beverage(s) in the order.

In various embodiments, the process 900 at block 912 and/or block 914 (or after block 914) can also include receiving an acknowledgment (ACK) notification from the selected store, storing a record of the order and the selected store, storing a record of the ACK notification, and/or the like. The records can allow the customer to view a confirmation of their order and/or a real-time status related to their order (e.g., based on a queue at the selected restaurant). Additionally, or alternatively, the record can allow the mesh network (e.g., under the control of the remote system) to split various aspects of the order, such as costs associated with producing the beverages and/or maintaining the beverage robots, sales from the order, profits from the order, reviews and/or ratings associated with the beverages in the order, and/or the like.

Although the blocks 902-914 of the process 900 are discussed and illustrated in a particular order, the process 900 illustrated in FIG. 9 is not so limited. For example, various steps of the process 900 can be performed in a different order. In these and other embodiments, any of the blocks 902-914 of the process 900 can be performed before, during, and/or after any of the other blocks 902-914 of the process 900. In a specific, non-limiting example, block 906 can be performed generally simultaneously with block 904 to determine a reception time at each of the second stores as they are identified. Moreover, a person of ordinary skill in the relevant art will recognize that the illustrated process 900 can be altered and still remain within these and other embodiments of the present technology.

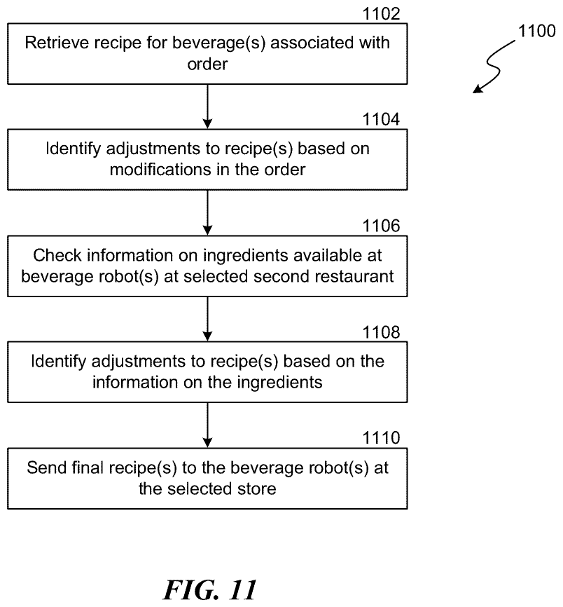

FIG. 11 is a flow diagram of a process 1100 for improving consistency in the beverages produced by a mesh network of beverage robots in accordance with some embodiments of the present technology. Similar to the processes discussed above with reference to FIGS. 7 and 9, the process 1100 can be executed by any suitable computing device (or combination of computing devices) in a mesh network of the type discussed above. Purely by way of example, the process 1100 can be executed by one or more computing devices in the remote system 610 of FIG. 6 implementing the platform 300 discussed above with reference to FIG. 3; a computing device with the subsystem 400 discussed above with reference to FIG. 4, such as the beverage robot 622 and/or the POS system 624 of FIG. 6; and/or the like. Further, although discussed herein in the context of being executed entirely within a single component (e.g., entirely within the remote system 610 of FIG. 6), it will be understood that a first subset of the process 1100 can be executed by a different computing device than a second subset of the process 1100.

The process 1100 begins at block 1102 by retrieving a recipe for each of the beverage(s) associated with the order. In various embodiments, retrieving the recipe can include, for each recipe, accessing a central database (e.g., at the remote system) with a record of each recipe as customized and/or tailored to each of the stores; accessing another database (e.g., in onsite computing systems at each of the stores, POS systems at the stores, a third party database, and/or the like) via a query to the database for the recipes; and/or querying one or more of the beverage robots in the mesh network for the recipes. Further, in some embodiments, the recipe for each of the beverage(s) in the order is received with the order, allowing the recipes to be retrieved from the order information.

At block 1104 the process 1100 includes identifying one or more adjustments to each of the recipe(s) based on the modifications received with the order. The modifications can be for extra (or less) ice, sugar and/or any other sweetener, carbonation, and/or the like. Additionally, or alternatively, the modifications can include changes to ratios of ingredients (e.g., extra of one or more ingredients, less of one or more ingredients, and/or the like), additions of one or more ingredients (e.g., adding a juice concentrate), and/or subtractions of one or more ingredients (removing an ingredient, removing ice, and/or the like). Additionally, or alternatively, the modifications can include swapping temperature profiles (e.g., selecting to have a hot beverage (e.g., a latte) iced; electing to have an iced beverage hot; and/or the like).

The adjustments to the recipe are based on the modifications in the order to allow the beverage robots to prepare the beverage(s) according to the customer's preferences. In addition to the adjustments based on user inputs, the process 1100 can include back-end adjustments that account for differences in ingredient batches (e.g., varying bitterness in coffee across different batches, different concentrations and/or sweetness of juices based on different ingredient batches, different sources for ingredients, and/or the like) to help improve the consistency of flavor profiles for beverages prepared at different stores.

For example, at block 1106 the process 1100 includes checking information on ingredients available at the beverage robot(s) at the selected store. The information can include a batch number, a source identifier, raw data on the ingredients (e.g., acidity level, sugar levels, concentration information, and/or the like), and/or the like. In turn, the batch number and/or source identifier can allow the process to retrieve raw data and/or other information on the ingredients available at the beverage robot(s).

At block 1108, the process 1100 includes identifying one or more adjustments to the recipe(s) based on the information on the ingredients retrieved at block 1106. The adjustments can help account for variations in the ingredients to help improve a consistency in the flavor profile of beverages prepared by each of the beverage robots in the mesh network. Purely by way of example, the adjustments could include using more (or less) of a juice concentrate based on variations in different batches of the juice concentrate (e.g., variations in sweetness, variations in concentration, and/or the like). In another example, the adjustments can include using more (or less) simple syrup (or other sweetener) to compensate for variations in the acidity of batches of a coffee concentrate. Further, the adjustments identified at block 1108 can be based at least partially on the adjustments identified at block 1104. Purely by way of example, where an order requests half of a juice concentrate in their beverage and the batch information identifies that the batch available in the beverage robots at the selected store is especially concentrated, the adjustments at block 1108 can further reduce the amount of the juice concentrate added to the beverage. In this example, the adjustments at block 1108 can create a flavor profile similar (or identical) to a half ratio of the juice concentrate when dispensed from a normal batch.

At block 1110, the process 1100 includes sending a final recipe for each of the beverage(s) in the order to the selected store. As a result, similar to the discussion above, the process 1100 can cause the beverage robot(s) in the selected store to produce the order according to the adjusted recipe(s). By preparing and sharing the adjusted recipe for each of the beverage(s) in the order, the process 1100 can cause the beverage robots in the selected store to prepare the beverage(s) with the same flavor profile and/or other characteristics as if the beverage(s) were prepared by a first store, incorporating any changes specific to the order and/or based on variations in the ingredients available at the selected store (e.g., including variations in ingredients available at the first store). As a result, the process 1100 can help improve a consistency in the beverage(s) in the order across multiple different store locations and/or variations in the ingredients available at the different locations.

Although the blocks 1102-1110 of the process 1100 are discussed and illustrated in a particular order, the process 1100 illustrated in FIG. 11 is not so limited. For example, various steps of the process 1100 can be performed in a different order. In these and other embodiments, any of the blocks 1102-1110 of the process 1100 can be performed before, during, and/or after any of the other blocks 1102-1110 of the process 1100. Purely by way of example, the process 1100 can execute block 1106 before (or while) executing block 1104 to check information on ingredients available at the beverage robots before (or while) identifying adjustments to the recipes based on the order. Indeed, in some embodiments, the information on the ingredients is checked while determining which stores (and/or which robots in a store) are eligible to receive an order. Moreover, a person of ordinary skill in the relevant art will recognize that the illustrated process 1100 can be altered and still remain within these and other embodiments of the present technology.

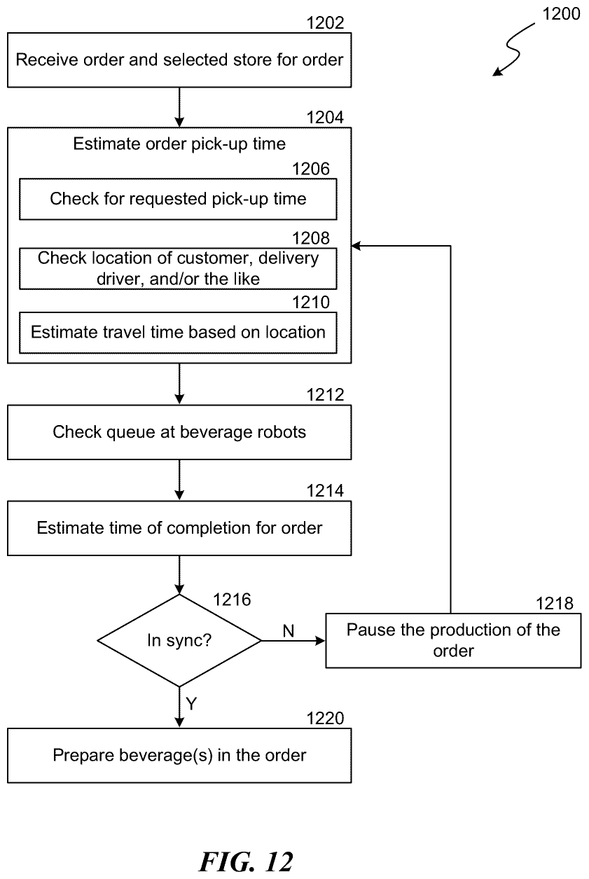

FIG. 12 is a flow diagram of a process 1200 for timing orders in production at a plurality of beverage robots in accordance with some embodiments of the present technology. Similar to the processes discussed above with reference to FIGS. 7, 9, and 11, the process 1200 can be executed by any suitable computing device (or combination of computing devices) in a mesh network of the type discussed above. Purely by way of example, the process 1200 can be executed by one or more computing devices in the remote system 610 of FIG. 6 implementing the platform 300 discussed above with reference to FIG. 3; a computing device with the subsystem 400 discussed above with reference to FIG. 4, such as the beverage robot 622 and/or the POS system 624 of FIG. 6; and/or the like. Further, although discussed herein in the context of being executed entirely within a single component (e.g., entirely within the remote system 610 of FIG. 6, within one of the beverage robots at the selected store, and/or the like), it will be understood that a first subset of the process 1200 can be executed by a different computing device than a second subset of the process 1200.

The process 1200 begins at block 1202 by receiving an order and a selected store for the order. Purely by way of example, block 1202 of the process 1200 can be triggered at block 724 of FIG. 7, block 912 of FIG. 9, and/or the like once a customer has submitted their order and selected which store to receive the order from.

At block 1204, the process 1200 includes estimating an order pick-up time. The estimated order pick-up time can be based on a variety of timing-related information. For example, at subblock 1206, the process 1200 includes checking for a requested pick-up time in the order (e.g., pick-up in 1 hour, pick-up at 1:30 PM, and/or the like). When the order includes a requested pick-up time, the process 1200 can use the requested pick-up time as the estimated order pick-up time and/or an initial estimate that is refined by additional timing-related information (e.g., to match the estimated pick-up time with the actual arrival time of the customer).

At optional subblock 1208, the process 1200 includes checking a location of the customer and/or a delivery person associated with the order. For example, the process 1200 can receive geographic information from a user device associated with the customer and/or the delivery person. The user device can be a smartphone of a customer, a delivery person, and/or the like. The geographic information can be received as part of an order (e.g., shared by the user device when submitting a mobile order), continuously (or periodically) after receiving the order (e.g., from an app on the smartphone), as part of an assignment of the order to a delivery person, and/or the like. The geographic information can include GPS data indicating the location of the user device, information on how the associated user is traveling (e.g., walking, biking, driving, riding transit, and/or the like), and/or any information on a planned route to the vending location (e.g., including any stops a delivery person will make on the way).

At optional subblock 1210, the process 1200 includes determining an estimated arrival time based on the geographic information. The process 1200 can then use the estimated arrival time as the estimated actual pick-up time for the order. Determining the estimated arrival time can include generating a route between the location of the user device and the vending location based on various modes of travel, determining traffic information, and estimating travel time on the route. Additionally, or alternatively, determining the estimated travel time can include referencing average travel times along the route between the user device and the vending location.

At block 1212, the process 1200 includes checking a queue of orders at the beverage robots at the selected store. Checking the queue at the beverage robots can include accessing a central, updated database (e.g., a database stored at the remote system and/or one of the beverage robots), querying another database for the queue (e.g., the POS system at the store, the onsite computing system at the store, and/or the like), and/or querying the beverage robots at the store for their current queue.

At block 1214, the process 1200 includes estimating a time of completion for each beverage in the order (and/or the order overall) based on the queue information from block 1212. The estimated completion time can be based on an estimated preparation time for each of the beverages in the queue(s) plus an estimated preparation time for the beverage(s) in the order. In some embodiments, the estimated preparation time is based on an average preparation time per beverage. In some embodiments, the estimated preparation time is based on preparation times specific to the beverages in the queue(s).

At decision block 1216, if the estimated completion time is generally in sync with the estimated pick-up time (e.g., the requested pick-up time, the estimated time of arrival, and/or the like), the process 1200 continues to block 1220 to prepare the beverage(s) in the order based on their current position in the queue. In various embodiments, for the process 1200 to consider the estimated completion time to be generally in sync with the estimated arrival time, the estimated completion time must be within 1 minute, within 2 minutes, within 5 minutes, within 10 minutes, within 15 minutes, and/or within any other suitable period of the estimated pick-up time.

Conversely, if the estimated completion time is not generally in sync with the estimated arrival time, the process 1200 continues to block 1218 to pause the production of the order. The pause can help improve the synchronization between the completion time of the order and the order pick-up time. The improved synchronization, in turn, can help improve the freshness of the beverages produced by the beverage robots at the selected store (e.g., by preventing the beverages from being produced significantly before the order is actually picked up).

For example, the process 1200 at block 1218 pauses the production of the order for a predetermined amount of time (e.g., 30 seconds, 1 minute, 5 minutes, 10 minutes, 30 minutes, and/or any other suitable amount of time). In another example, the process 1200 can pause the production of the order until closer to the estimated pick-up time (e.g., until 5 minutes before the estimated pick-up time). In yet another example, the process 1200 can pause the production of the order until a condition to resume is received (e.g., a determination that the user is within a predetermined distance and/or travel time from the vending location). Accordingly, for example, the process 1200 can return to block 1204 after pausing the production of the order to generate an updated estimated pick-up time (e.g., based on updated geographic information from the user device), check the queue(s) at the beverage robots at the selected store, and/or estimate a new time of completion for the order.

The process 1200 can then repeat these steps any suitable number of times until the estimated time of completion is generally in sync with the estimated time of arrival. It will be understood, however, that the process 1200 can skip any of the steps discussed above during the loop. Purely by way of example, the process 1200 can use the original estimated time of arrival for each loop (e.g., skipping block 1204) to avoid needing to repeatedly receive geographic information from the user device. Further, in some embodiments, the process 1200 places the order back into the queue after the pause, without re-evaluating the estimated time of completion and the estimated arrival time.

Although the blocks 1202-1220 of the process 1200 are discussed and illustrated in a particular order, the process 1200 illustrated in FIG. 12 is not so limited. For example, various steps of the process 1200 can be performed in a different order. In these and other embodiments, any of the blocks 1202-1220 of the process 1200 can be performed before, during, and/or after any of the other blocks 1202-1220 of the process 1200. Purely by way of example, the process 1200 can execute all (or a portion of) blocks 1212-1214 before block 1204 to estimate a completion time for the order before estimating the order pick-up time. Moreover, a person of ordinary skill in the relevant art will recognize that the illustrated process 1200 can be altered and still remain within these and other embodiments of the present technology.

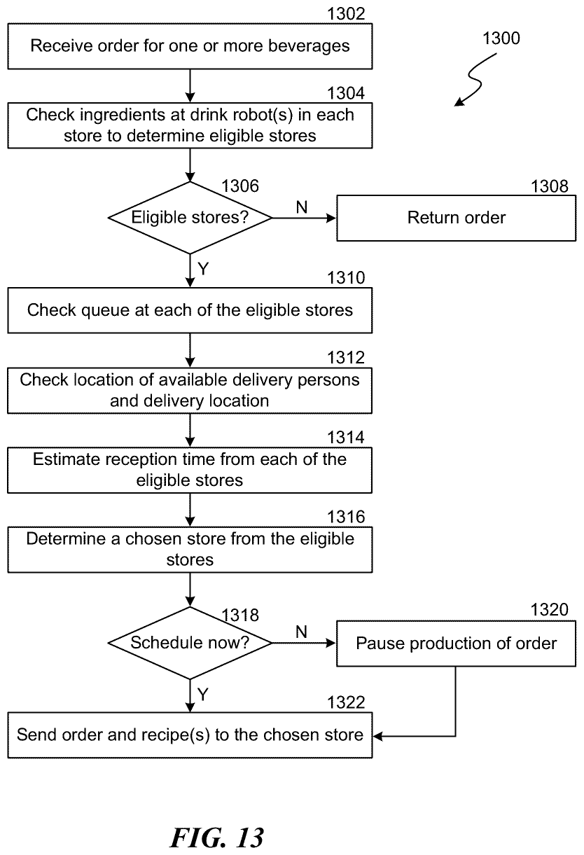

FIG. 13 is a flow diagram of a process 1300 for managing a network having a plurality of beverage robots in accordance with some embodiments of the present technology. More specifically, the process 1300 can be executed to help manage orders to a network of stores that each have one or more beverage robots (e.g., multiple stores associated with a franchise, networked stores, and/or the like). Similar to the processes discussed above with reference to FIGS. 7, 9, 11, and 12, the process 1300 can be executed by any suitable computing device (or combination of computing devices) in a mesh network of the type discussed above. Purely by way of example, the process 1300 can be executed by one or more computing devices in the remote system 610 of FIG. 6 implementing the platform 300 discussed above with reference to FIG. 3; a computing device with the subsystem 400 discussed above with reference to FIG. 4, such as the beverage robot 622 and/or the POS system 624 of FIG. 6; and/or the like. Further, although discussed herein in the context of being executed entirely within a single component (e.g., entirely within the remote system 610 of FIG. 6, within one of the beverage robots at the selected store, and/or the like), it will be understood that a first subset of the process 1300 can be executed by a different computing device than a second subset of the process 1300.

The process 1300 begins at block 1302 by receiving an order for one or more beverages from the mesh network. The beverage can be from, for example, a menu of a franchise with multiple stores, a common menu of beverages offered by networked stores, a menu specific to a single store with common ingredients in the mesh network, and/or the like. Similar to the discussion above, the order can be received from a variety of sources, such as various web-based platforms, app-based platforms, and/or the like. In some embodiments, the order is received at a remote system directly from the customer associated with the order. In some embodiments, the order is received at the remote system from another platform (e.g., from a specific vending location, from a third-party ordering platform, and/or the like).

At block 1304, the process 1300 includes checking the ingredients available at each beverage robot in the mesh network to identify eligible stores (e.g., stores that have beverage robots with the ingredients necessary to produce the order). As discussed above, each of the beverage(s) in the order is associated with a recipe that requires one or more ingredients (e.g., concentrated juices, syrups, coffee, tea, and/or the like; water; sparkling and/or carbonated water; milk and/or milk alternatives; and/or the like). Accordingly, the check at block 1304 can begin by retrieving the recipe for each of the beverage(s) in the order to compile a list of the ingredients required to produce the order. The check at block 1304 can then include checking the ingredients available at beverage robots in each beverage robot (e.g., a list of ingredients at the beverage robots, ingredient levels, and/or the like) to identify the stores available to produce the beverage(s) in the order as eligible stores.

At decision block 1306, if the process 1300 has not identified any eligible stores, the process 1300 moves to block 1308 to return the order to a point of sale associated with the order. The return can include an error message to explain the return. The error message can indicate that one or more beverages could not be prepared, identify the beverages that could not be prepared, identify missing ingredients (e.g., that may be associated with other beverages offered by the point of sale), and/or the like. Conversely, if the process 1300 identified any eligible stores, the process 1300 moves to block 1310.

At block 1310, the process 1300 includes checking the queue at the beverage robots in each of the eligible stores. Checking the queue at the beverage robots can include accessing a central, updated database (e.g., a database stored at the remote system and/or one of the beverage robots), querying another database for the queue (e.g., the POS system at the store, the onsite computing system at the store, and/or the like), and/or querying the beverage robots at the store for their current queue.

At block 1312, the process 1300 includes checking a location of one or more delivery persons and a delivery location associated with the order. The delivery persons can be associated directly with the mesh network (e.g., delivery staff for a franchise, delivery staff associated with a remote system that integrates with store locations, and/or the like) and/or communicably coupled to the mesh network (e.g., third-party delivery persons). Checking the location of the delivery persons can include receiving geographic information (e.g., GPS signals) from mobile devices associated with the delivery persons (e.g., through a delivery app on a delivery person's phone). In some embodiments, checking the location of the delivery person includes checking any planned travel routes (e.g., delivery routes for current orders, assigned stops, planned breaks, and/or the like). Checking the delivery location can include reviewing the order for an indication of a delivery location (e.g., a delivery address) and/or receiving geographic information (e.g., GPS signals) from the POS system associated with the order (e.g., through an app on a customer's phone).

At block 1314, the process 1300 includes estimating a reception time from each of the eligible stores based on the queue information, the location of the delivery persons, and the delivery location associated with the order. That is, in this context, the reception time is the time a customer will actually receive the order from one of the eligible stores based on the time it will take a store to produce the order, the time it will take a delivery person to arrive at the store to retrieve the order, and/or the time it will take the delivery person to deliver the order to the customer. For example, the process 1300 at block 1314 can use the queue information at the beverage robots to estimate the completion time for the order at each of the eligible stores, then use the location of the delivery persons to identify which delivery person is closest to the store and estimate their arrival time. For each of the eligible stores, the process 1300 at block 1314 can use the later of the estimated completion time and the estimated arrival time as an estimated pick-up time. The process 1300 at block 1314 can then estimate a delivery time based on a travel time between each of the eligible stores and the delivery location and add the delivery time to the estimated pick-up time.

In a specific, non-limiting example, the eligible stores can include a first store, a second store, and a third store. For the first store, the process 1300 can determine that the beverage robots will produce the order by 1:08 PM, that the closest delivery person could arrive at the first store at 1:15 PM, and that it will take a delivery person 12 minutes to travel from the first store to the delivery location. The process 1300 will choose 1:15 PM as the estimated pick-up time for the first store, then add 12 minutes to estimate 1:27 PM as the reception time. For the second store, the process 1300 can determine that the beverage robots will produce the order by 1:11 PM, that the closest delivery person could arrive at the second store at 1:10 PM, and that it will take a delivery person 8 minutes to travel from the second store to the delivery location. The process 1300 will choose 1:11 PM as the estimated pick-up time for the second store, then add 8 minutes to estimate 1:19 PM as the reception time. For the third store, the process 1300 can determine that the beverage robots will produce the order by 1:18 PM, that the closest delivery person could arrive at the third store at 1:20 PM, and that it will take a delivery person 2 minutes to travel from the third store to the delivery location. The process 1300 will choose 1:20 PM as the estimated pick-up time for the third store, then add 2 minutes to estimate 1:22 PM as the reception time.

At block 1316, the process 1300 includes determining a chosen store from the eligible stores based at least partially on the estimated reception time. In some embodiments, the process 1300 chooses the eligible store with the earliest estimated reception time. For example, in the specific example discussed above, the process 1300 can choose the second store since the 1:19 PM reception time is the earliest reception time. In some embodiments, the process 1300 chooses the eligible store based on the reception time and one or more other factors. For example, the process 1300 can select between estimated reception times within a predetermined range (e.g., 5 minutes) based on which store is associated with a smaller time between the estimated completion and the estimated reception time. Returning again to the specific example discussed above, the estimated reception time from the third store is 3 minutes slower than the estimated reception time from the second store. However, the time between the estimated completion and the estimated reception time is 4 minutes, which is half of the 8 minutes between the estimated completion and the estimated reception at the second store. Accordingly, if the 3-minute difference in reception time is within an acceptable range, the process 1300 can choose the third store to increase a freshness of the order when it is received by the customer.

The determination at block 1316 can include assigning a delivery person (e.g., the closest delivery person) to the order. The assignment at block 1316 can include sending information about the order, the chosen store, and/or the delivery location to the delivery person. Additionally, the assignment at block 1316 can include updating a status of the delivery person in the mesh network (e.g., adding information about the delivery and/or the delivery route to stored geographic information for the delivery person, taking the delivery person out of a queue of eligible delivery persons, and/or the like). As a result, the assignment at block 1316 can help prevent future iterations through the process 1300 from choosing a store based on the location and/or availability of the assigned delivery person without considering the travel time associated with the assigned delivery.

In some embodiments, determining a chosen store at block 1306 includes presenting the eligible stores to the customer to receive a selection (e.g., similar to the discussion above with respect to blocks 904-910 of FIG. 9). In such embodiments, the presentation of the options can include presenting estimated reception times, the estimated completion times, estimated transportation times, and/or estimated times between the estimated completion time and the estimated reception time for each of the eligible stores. Additionally, or alternatively, the process 1300 at block 1306 can determine which of the eligible stores would be more efficient for an assigned delivery person (e.g., based on their current location, the delivery location, and/or any other pick-ups and/or deliveries in their queue to reduce fuel consumption, travel times, distances traveled, and/or the like). In some such embodiments, determining a chosen store at block 1306 includes presenting a subset of the eligible stores to the customer to receive a selection. The subset can include the store the customer ordered from, one or more earlier options, and/or one or more alternatives that are more efficient for the delivery person. The alternatives that are more convenient for the delivery person can be accompanied by various incentives for the customer to choose them (e.g., as compensation for a later reception time). For example, the alternatives can include a discount on the order, a coupon for future orders, a voucher for prioritized delivery in future orders, a free item, and/or the like. The incentives can help encourage the customer to accept a slower, more efficient delivery.

At decision block 1318, the process 1300 determines whether to schedule the order at the chosen store now. For example, if the estimated completion time for the order is not in sync with the estimated pick-up time, the process 1300 at decision block 1318 can decide to move to block 1320 to pause the production of the order. The pause can be for any suitable period of time, until the process 1300 determines the estimated completion time is in sync with the estimated pick-up time, and/or a restart condition is detected (e.g., that the delivery person is within 10 minutes of the chosen store). As discussed above, the pause can help improve the synchronization between the completion time of the order and the order pick-up time and, in turn, help improve the freshness of the beverages produced by the beverage robots at the selected store.

Conversely, if the estimated completion time is generally in sync with the estimated pick-up time, the process 1300 at decision block 1318 can decide to move to block 1322. At block 1322, the process 1300 includes sending the order and recipes associated with each of the beverage(s) in the order to the chosen store. As a result, the process 1300 can cause the beverage robot(s) in the chosen store to produce the order.

Although the blocks 1302-1324 of the process 1300 are discussed and illustrated in a particular order, the process 1300 illustrated in FIG. 13 is not so limited. For example, various steps of the process 1300 can be performed in a different order. In these and other embodiments, any of the blocks 1302-1324 of the process 1300 can be performed before, during, and/or after any of the other blocks 1302-1324 of the process 1300. Moreover, a person of ordinary skill in the relevant art will recognize that the illustrated process 1300 can be altered and still remain within these and other embodiments of the present technology.

### Examples

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A method for operating a network of a plurality of beverage robots, the method comprising:
receiving an order for a beverage from a first individual beverage robot from the plurality of beverage robots at a first store, wherein the beverage is associated with a recipe requiring one or more ingredients;
identifying one or more second stores, wherein each individual second store has a second individual beverage robot available to prepare the beverage based on ingredients available at the second individual beverage robot;
determining a first reception time at the first store, the first reception time associated with when a user would receive the beverage from the first store;
for each individual second store in the one or more second stores determining a second reception time at the individual second store, the second reception time associated with when the user would receive the beverage from the individual second store;
identifying, from the one or more second stores, a earlier second store based on the second reception time at the earlier second store being before the first reception time;
presenting the earlier second store to the user to allow the user to choose between the first store and the earlier second store; and
in response to a selection of the earlier second store from the user, sending the order to the earlier second store to be prepared by the second individual beverage robot at the earlier second store.

2. The method of example 1, wherein:
determining the first reception time comprises calculating a travel time between a current location of the user and the first store; and
for each individual second store in the one or more second stores, determining the second reception time comprises calculating a travel time between the current location of the user and the individual second store.

3. The method of any of examples 1 and 2, wherein:

determining the first reception time comprises checking a queue at the first individual beverage robot at the first store; and
for each individual second store in the one or more second stores, determining the second reception time comprises checking a queue at the second individual beverage robot at the individual second store.

4. The method of any of examples 1-3, wherein the recipe for the beverage is a customized recipe at the first store, and wherein the method further comprises sending the customized recipe to the second individual beverage robot at the earlier second store.

5. The method of any of examples 1-3, wherein the recipe for the beverage is a customized recipe at the first store, and wherein the method further comprises:
receiving the customized recipe from the first store;
checking information on the ingredients available at the second individual beverage robot in the earlier second store, wherein the information includes a batch number and/or source identifier associated with the ingredients;
identifying one or more adjustments to the customized recipe based on the information on the ingredients to account for variations between ingredients available at the first store and the ingredients available at the second individual beverage robot in the earlier second store; and
sending the adjusted recipe to the second individual beverage robot at the earlier second store.

6. The method of example 5, wherein the one or more adjustments are first adjustments, and wherein the method further comprises identifying one or more second adjustments to the recipe based on modifications to the customized recipe received with the order.

7. The method of any of examples 5 and 6, wherein the batch number and/or source identifier associated with the ingredients is associated with one or more taste qualities of the ingredients.

8. The method of any of examples 1-7, further comprising:
estimating an order pick-up time at the earlier second store;
checking a queue at the second individual beverage robot at the earlier second store to determine an estimated completion time for the beverage;
determining that the beverage will be completed at least a predetermined amount of time before the order pick-up time; and
pausing preparation of the beverage in response to the determination.

9. The method of example 8, wherein estimating the order pick-up time comprises:
checking a current geographic location of the user based on geographic position signals (GPS) received from a user device associated with the user; and
calculating a travel time to the earlier second store based on the current geographic location of the user.

10. The method of any of examples 8 and 9, wherein estimating the order pick-up time comprises identifying a requested pick-up time in the order.

11. A method for operating a network of a plurality of beverage robots, the method comprising:
receiving an order for a beverage from a first beverage robot from the plurality of beverage robots, wherein the beverage is associated with a recipe requiring one or more ingredients;
identifying a subset of beverage robots based on the order, the subset of beverage robots comprising the first beverage robot and one or more second beverage robots able to prepare the beverage based on the one or more ingredients required by the recipe;
for each individual beverage robot in the subset of beverage robots, determining an estimated reception time at the individual beverage robot, the estimated reception time associated with a time a user would receive their order from the individual beverage robot;
presenting the subset of beverage robots to the user with an indication of the estimated reception time at each of the individual beverage robots;
receiving an indication of a selected beverage robot from the subset of beverage robots; and
sending the order to the selected beverage robot to cause the order to be prepared by the selected beverage robot.

12. The method of example 11, wherein, for each of the individual beverage robots in the subset of beverage robots, determining the estimated reception time comprises checking a queue at the individual beverage robot.

13. The method of any of examples 11 and 12, wherein, for each of the individual beverage robots in the subset of beverage robots, determining the estimated reception time comprises calculating a travel time between a current location of the user and the individual beverage robot.

14. The method of any of examples 11-13, wherein the recipe for the beverage is specific to a first store associated with the first beverage robot, and wherein the method further comprises:
receiving the recipe from the first store;
checking information on the ingredients available at the selected beverage robot, wherein the information includes a batch number and/or source identifier associated with the ingredients available at the selected beverage robot;
identifying one or more adjustments to the recipe based on the information on the ingredients available at the selected beverage robot; and
sending the adjusted recipe to the selected beverage robot.

15. The method of any of examples 11-14, further comprising:
estimating an order pick-up time at the selected beverage robot; and
queuing the order at the selected beverage robot to be completed a predetermined amount of time before the order pick-up time.

16. A robotic system, comprising:
a plurality of beverage robots, wherein each individual beverage robot in the plurality of beverage robots stores a plurality of ingredients, wherein the plurality of beverage robots comprise a first beverage robot in a first store and a second beverage robot positioned in a second store; and
a computing system communicatively coupled to each of the plurality of beverage robots, the computing system configured to:
   receive, from a user, an order for one or more beverages from the first beverage robot at the first store, wherein each of the one or more beverages is associated with a recipe requiring one or more ingredients;
   identify that the user can receive the one or more beverages in the order from the second beverage robot at an earlier time than from the first beverage robot;
   present the second store to the user to allow the user to select between the first store and the second store; and
   in response to a selection of the second store from the user, send the order to the second store to cause the second beverage robot to prepare each of the one or more beverages in the order.

17. The robotic system of example 16, wherein the computing system is further configured to:
receive, from the second store, an acknowledgment (ACK) notification confirming reception of the order, wherein the ACK notification; and
provide, to the user, a confirmation that the second store received the order.

18. The robotic system of any of examples 16 and 17, wherein identifying that the user can receive the one or more beverages in the order from the second beverage robot at the earlier time than from the first beverage robot comprises:
determining a first reception time from the first beverage robot, wherein determining the first reception time includes:
   calculating a first time of arrival based on a first travel time between a current location of the user and the first store;
   checking a first queue at the first beverage robot, wherein the first queue is associated with a number of beverages already assigned to be prepared by the first beverage robot ahead of the one or more beverages in the order;
   determining a first estimated completion time for each of the one or more beverages in the order; and
   identifying the first reception time based on which of the first time of arrival and the first estimated completion time is later; and
determining a second reception time from the second beverage robot, wherein determining the second reception time includes:
   calculating a second time of arrival based on a second travel time between the current location of the user and the second store;
   checking a second queue at the second beverage robot, wherein the second queue is associated with a number of beverages already assigned to be prepared by the second beverage robot ahead of the one or more beverages in the order;
   determining a second estimated completion time for each of the one or more beverages in the order; and
   identifying the second reception time based on which of the second time of arrival and the second estimated completion time is later.

19. The robotic system of any of examples 16-18, wherein at least one of the one or more beverages in the order is associated with customized recipe at the first store, and wherein the computing system is further configured to, in response to a selection of the second store from the user, send the customized recipe to the second beverage robot to allow the second beverage robot to prepare the at least one beverage according to the customized recipe.

20. The robotic system of any of examples 16-19, wherein the computing system is further configured to:

check whether an estimated time of arrival for the user at the second store is in sync with an estimated completion time for the one or more beverages in the order; and
in response to a determination that the estimated time of arrival is not in sync with the estimated completion time, send a message to the second beverage robot causing the second beverage robot to pause the preparation of the one or more beverages in the order.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A method for operating a network of a plurality of beverage robots, the method comprising:
receiving an order for a beverage from a first individual beverage robot from the plurality of beverage robots at a first store, wherein the beverage is associated with a recipe requiring one or more ingredients;
identifying one or more second stores, wherein each individual second store has a second individual beverage robot available to prepare the beverage based on ingredients available at the second individual beverage robot;
determining a first reception time at the first store, the first reception time associated with when a user would receive the beverage from the first store;
for each individual second store in the one or more second stores determining a second reception time at the individual second store, the second reception time associated with when the user would receive the beverage from the individual second store;
identifying, from the one or more second stores, a earlier second store based on the second reception time at the earlier second store being before the first reception time;
presenting the earlier second store to the user to allow the user to choose between the first store and the earlier second store; and
in response to a selection of the earlier second store from the user, sending the order to the earlier second store to be prepared by the second individual beverage robot at the earlier second store.

2. The method of claim 1, wherein:
determining the first reception time comprises calculating a travel time between a current location of the user and the first store; and
for each individual second store in the one or more second stores, determining the second reception time comprises calculating a travel time between the current location of the user and the individual second store.

3. The method of claim 1, wherein:
determining the first reception time comprises checking a queue at the first individual beverage robot at the first store; and
for each individual second store in the one or more second stores, determining the second reception time comprises checking a queue at the second individual beverage robot at the individual second store.

4. The method of claim 1, wherein the recipe for the beverage is a customized recipe at the first store, and wherein the method further comprises sending the customized recipe to the second individual beverage robot at the earlier second store.

5. The method of claim 1, wherein the recipe for the beverage is a customized recipe at the first store, and wherein the method further comprises:
receiving the customized recipe from the first store;
checking information on the ingredients available at the second individual beverage robot in the earlier second store, wherein the information includes a batch number and/or source identifier associated with the ingredients;
identifying one or more adjustments to the customized recipe based on the information on the ingredients to account for variations between ingredients available at the first store and the ingredients available at the second individual beverage robot in the earlier second store; and
sending the adjusted recipe to the second individual beverage robot at the earlier second store.

6. The method of claim 5, wherein the one or more adjustments are first adjustments, and wherein the method further comprises identifying one or more second adjustments to the recipe based on modifications to the customized recipe received with the order.

7. The method of claim 5, wherein the batch number and/or source identifier associated with the ingredients is associated with one or more taste qualities of the ingredients.

8. The method of claim 1, further comprising:
estimating an order pick-up time at the earlier second store;
checking a queue at the second individual beverage robot at the earlier second store to determine an estimated completion time for the beverage;
determining that the beverage will be completed at least a predetermined amount of time before the order pick-up time; and
pausing preparation of the beverage in response to the determination.

9. The method of claim 8, wherein estimating the order pick-up time comprises:
checking a current geographic location of the user based on geographic position signals (GPS) received from a user device associated with the user; and
calculating a travel time to the earlier second store based on the current geographic location of the user.

10. The method of claim 8, wherein estimating the order pick-up time comprises identifying a requested pick-up time in the order.

11. A method for operating a network of a plurality of beverage robots, the method comprising:
receiving an order for a beverage from a first beverage robot from the plurality of beverage robots, wherein the beverage is associated with a recipe requiring one or more ingredients;
identifying a subset of beverage robots based on the order, the subset of beverage robots comprising the first beverage robot and one or more second beverage robots able to prepare the beverage based on the one or more ingredients required by the recipe;
for each individual beverage robot in the subset of beverage robots, determining an estimated reception time at the individual beverage robot, the estimated reception time associated with a time a user would receive their order from the individual beverage robot;
presenting the subset of beverage robots to the user with an indication of the estimated reception time at each of the individual beverage robots;
receiving an indication of a selected beverage robot from the subset of beverage robots; and
sending the order to the selected beverage robot to cause the order to be prepared by the selected beverage robot.

12. The method of claim 11, wherein, for each of the individual beverage robots in the subset of beverage robots, determining the estimated reception time comprises checking a queue at the individual beverage robot.

13. The method of claim 11, wherein, for each of the individual beverage robots in the subset of beverage robots, determining the estimated reception time comprises calculating a travel time between a current location of the user and the individual beverage robot.

14. The method of claim 11, wherein the recipe for the beverage is specific to a first store associated with the first beverage robot, and wherein the method further comprises:
receiving the recipe from the first store;
checking information on the ingredients available at the selected beverage robot, wherein the information includes a batch number and/or source identifier associated with the ingredients available at the selected beverage robot;
identifying one or more adjustments to the recipe based on the information on the ingredients available at the selected beverage robot; and
sending the adjusted recipe to the selected beverage robot.

15. The method of claim 11, further comprising:
estimating an order pick-up time at the selected beverage robot; and
queuing the order at the selected beverage robot to be completed a predetermined amount of time before the order pick-up time.

16. A robotic system, comprising:
a plurality of beverage robots, wherein each individual beverage robot in the plurality of beverage robots stores a plurality of ingredients, wherein the plurality of beverage robots comprise a first beverage robot in a first store and a second beverage robot positioned in a second store; and
a computing system communicatively coupled to each of the plurality of beverage robots, the computing system configured to:
receive, from a user, an order for one or more beverages from the first beverage robot at the first store, wherein each of the one or more beverages is associated with a recipe requiring one or more ingredients;
identify that the user can receive the one or more beverages in the order from the second beverage robot at an earlier time than from the first beverage robot;
present the second store to the user to allow the user to select between the first store and the second store; and
in response to a selection of the second store from the user, send the order to the second store to cause the second beverage robot to prepare each of the one or more beverages in the order.

17. The robotic system of claim 16, wherein the computing system is further configured to:
receive, from the second store, an acknowledgment (ACK) notification confirming reception of the order, wherein the ACK notification; and
provide, to the user, a confirmation that the second store received the order.

18. The robotic system of claim 16, wherein identifying that the user can receive the one or more beverages in the order from the second beverage robot at the earlier time than from the first beverage robot comprises:
determining a first reception time from the first beverage robot, wherein determining the first reception time includes:
calculating a first time of arrival based on a first travel time between a current location of the user and the first store;
checking a first queue at the first beverage robot, wherein the first queue is associated with a number of beverages already assigned to be prepared by the first beverage robot ahead of the one or more beverages in the order;
determining a first estimated completion time for each of the one or more beverages in the order; and
identifying the first reception time based on which of the first time of arrival and the first estimated completion time is later; and
determining a second reception time from the second beverage robot, wherein determining the second reception time includes:
calculating a second time of arrival based on a second travel time between the current location of the user and the second store;
checking a second queue at the second beverage robot, wherein the second queue is associated with a number of beverages already assigned to be prepared by the second beverage robot ahead of the one or more beverages in the order;
determining a second estimated completion time for each of the one or more beverages in the order; and
identifying the second reception time based on which of the second time of arrival and the second estimated completion time is later.

19. The robotic system of claim 16, wherein at least one of the one or more beverages in the order is associated with customized recipe at the first store, and wherein the computing system is further configured to, in response to a selection of the second store from the user, send the customized recipe to the second beverage robot to allow the second beverage robot to prepare the at least one beverage according to the customized recipe.

20. The robotic system of claim 16, wherein the computing system is further configured to:
check whether an estimated time of arrival for the user at the second store is in sync with an estimated completion time for the one or more beverages in the order; and
in response to a determination that the estimated time of arrival is not in sync with the estimated completion time, send a message to the second beverage robot causing the second beverage robot to pause the preparation of the one or more beverages in the order.
